(19) United States
(12) Patent Application Publication
(10) Pub. No.: US 2024/0273427 A1
(43) Pub. Date: Aug. 15, 2024

(54) ELECTRONIC PLATFORM FOR IMPLEMENTING A MULTI-MODEL ARCHITECTURE FOR LINKING SPEAKER AND ATTENDEE ENTITY PROFILES

(71) Applicant: ZS Associates, Inc., Evanston, IL (US)

(72) Inventors: Asheesh Shukla, Lower Gwynedd, PA (US); Arrvind Sunder, Chicago, IL (US); Albert Whangbo, Durham, NC (US); Siddharth Kumar, Robbinsville, NJ (US); Krishnakalyan A, Philadelphia, PA (US); Sambit Nandi, Pune (IN); Tejaswini Sawakhande, Lawrenceville, NJ (US); Wenhao Xia, Evanston, IL (US); Sandeep Bansal, Pune (IN); Geetanjali Mishra, Bangalore (IN); Kanika Singh, Bangalore (IN); Viresh Dhawan, Pune (IN); Rohan Chouthai, Cambridge, MA (US); Siddharth Pandit, New Delhi (IN); Arpita Pattanayak, New Delhi (IN); Kiran Kolli, Bangalore (IN)

(73) Assignee: ZS Associates, Inc., Evanston, IL (US)

(21) Appl. No.: 18/439,958

(22) Filed: Feb. 13, 2024

Related U.S. Application Data
(60) Provisional application No. 63/445,598, filed on Feb. 14, 2023.

(51) Int. Cl. G06Q 10/0631

(52) U.S. Cl. CPC G06Q 10/063112

(57) ABSTRACT

Disclosed herein are methods and systems for implementing a multi-model computer architecture for entity identification. A method includes receiving data regarding a plurality of entities. The method includes generating a plurality of entity profiles for the plurality entities and a network graph data structure (e.g., a node graph) comprising edges between nodes for the plurality of entity profiles. The method includes executing a model using identifiers of the plurality of entity profiles, an event topic, and the edges between the nodes as input to generate one or more composite scores for the plurality of entity profiles. The method includes selecting one or more entities for the event based on the generated one or more composite scores. The method includes generating a record comprising associations between identifications of the entities and the event.

### CROSS-REFERENCE TO RELATED APPLICATIONS

This application claims the benefit of priority to U.S. Provisional Application No. 63/445,598, filed Feb. 14, 2023, the entirety of which is incorporated by reference herein.

### TECHNICAL FIELD

This application relates generally to implementing a multi-model machine learning architecture for linking speaker and attendee entity profiles to events.

### BACKGROUND

Linking speakers and attendees to events is a historically analogue process. For example, conventionally, a company may identify an individual as a potential speaker for an event given the event's topic based on the company learning about the individual or based on a publication the individual wrote. The company may then reach out to the individual asking if the individual can speak at the event. The company may also blindly send out invitations to the event to individuals associated with different companies that are involved in the same field as the speaker. In these cases, the company may identify individuals to whom to send the invitations using computer-implemented methods, such as a spreadsheet that contains a list of names that are associated with the event topic. Not only is this process tedious, time-consuming, and expensive, it often results in invited attendees not attending the event for a lack of interest in the speaker and/or a lack of interest in the topic.

During the past several years, drug developers in the public and private sectors have expressed keen interest in addressing this problem by selectively identifying the appropriate speakers and attendees for events. To do so, the drug developers would identify companies that research in the same area as the events and/or that have developed drugs in the same field as the topic of the event. The drug developers would identify the individuals that are employed by these companies from a database and either send invitations to the individuals using stored demographic data in the database or send the invitations to the companies for the companies to disperse. While this method may produce some results, uninteresting or uninfluential speakers may still speak at empty events or events with attendees with little interest in the speaker.

### SUMMARY

For the aforementioned reasons, there is a need to take advantage of the breadth of information that is transmitted over the Internet and between different types of data sources to identify speakers to speak at events and attendees to attend such events. More specifically, because the data that is available to help identify the speakers and attendees is available over the Internet, there is a need to develop computer models (e.g., machine learning and/or optimization models) that can automatically quantify and generate a meaningful output identifying the speakers and attendees using such data.

A system implementing the systems and methods described herein may overcome the aforementioned technical deficiencies by providing a series of individually trained computer models to select speakers and attendee profiles for events. For example, in some implementations, a processor of such a system may collect different types of data that was generated by or otherwise associated with entities in the medical field. Using the collected data, the processor may generate a network graph data structure that includes profiles (or nodes) with edges between each other indicating relationships (e.g., connections) between the entities in the medical field (e.g., one researcher may have worked and/or co-authored a publication with another researcher). The processor may also calculate metrics from the data. The processor may feed the relationships of the network data structure and the metrics into one or more models to calculate composite scores, speaker scores, attendee scores, and/or affinity scores for the profiles of the network graph data structure. By using metrics instead of the data itself, the processor may format the data into a format readable by the models (which may be helpful when the data involves text instead of numbers) and minimize the amount of data that needs to be used to select speakers and attendees for the event. The processor may then feed the composite, speaker, attendee, and/or affinity scores into an optimization model as input to identify the optimal speaker and attendees to attend the event. The processor may store an association linking the identified speaker and attendees to the event in a record. In this way, the processor may automatically generate lists of speakers and attendees to attend events using a series of models to optimize the speakers and attendees at such events. Using the sequence of models in this manner may enable faster processing with less latency than any conventional methods, which is particularly advantageous given the large amount of data that may be scraped for processing over the Internet.

In some cases, the processor implementing the systems and methods described herein may determine the optimal speakers and/or attendees for an event based on attributes of the event. For example, the processor may receive an identification of the topic for the event and feed the identification into the model that calculates the speaker, attendee, and/or affinity scores. The model may receive the identification of the topic and calculate scores that are higher for speakers and/or attendees that have an association with the topic in some manner (e.g., that work in the same field as the topic, have written a publication on the topic, work for a company that produces a product based on the topic, etc.). In another example, the processor may receive a desired geographic location of the event. The processor may use a set of rules to remove potential attendees from consideration if they are not within a defined radius of the location, or the processor may input the geographic location into the model to use as an input to determine speaker, attendee, and/or affinity scores. In the latter scenario, the model may generate higher scores for events that are at a geographic location closer to the speakers and/or attendees because entities that are in close proximity to an event may be more likely to attend.

As implemented, the processor may generate an interactive electronic platform discussed that can ingest clinical data about different entities in the medical field and automatically generate a record identifying a speaker and/or attendees for an event given a set of attributes input by a user. Through the platform, the processor may generate a graphical user interface that enables the user to select different attributes (e.g., event topic, geographic location, target audience, etc.) of an event. For example, a user may select a list of desired graphical locations or a list of prioritized attendees (i.e., a target list) according to the attendees' relevance to certain business objectives. The processor may automatically execute the series of models as described herein to identify the optimal speaker(s) and/or attendee(s) for the event based on these attributes input by the user. The processor may display the generated results to display identifiers of the identified speaker(s) and/or attendee(s) on the user interface. The user may view results and input different attributes to cause the processor to re-run the algorithm in real time with new parameters to re-determine speakers and attendees for the events based on the adjusted attributes. Thus, the processor may execute an electronic platform that is configured to give users the ability to control all aspects of an event during event planning.

In an embodiment, a method comprises receiving, by a processor from a plurality of data sources, clinical data regarding a plurality of medical entities; generating, by the processor from the clinical data, a plurality of entity profiles for the plurality medical entities and a network graph data structure comprising stored relationships between the plurality of entity profiles; executing, by the processor, a model using identifiers of the plurality of entity profiles, an event topic, and the stored relationships between the plurality of entity profiles as input to generate, for an event associated with the event topic, one or more composite scores for the plurality of entity profiles; selecting, by the processor, a speaker and one or more attendees for the event based on the generated one or more composite scores; and generating, by the processor, a record comprising associations between identifications of the speaker, the one or more attendees, and the event.

In another embodiment, a system comprises a server comprising a processor and a non-transitory computer-readable medium. The non-transitory computer-readable medium can contain instructions that when executed by the processor cause the processor to perform operations comprising receiving, from a plurality of data sources, clinical data regarding a plurality of medical entities; generating, from the clinical data, a plurality of entity profiles for the plurality medical entities and a network graph data structure comprising stored relationships between the plurality of entity profiles; executing a model using identifiers of the plurality of entity profiles, an event topic, and the stored relationships between the plurality of entity profiles as input to generate, for an event associated with the event topic, one or more composite scores for the plurality of entity profiles; selecting a speaker and one or more attendees for the event based on the generated one or more composite scores; and generating a record comprising associations between identifications of the speaker, the one or more attendees, and the event.

In another embodiment, a method comprises receiving, by a processor from a plurality of data sources, clinical data regarding a plurality of medical entities; generating, by the processor from the clinical data, a plurality of entity profiles for the plurality medical entities and a network graph data structure comprising stored relationships between the plurality of entity profiles; executing, by the processor, a model using identifiers of the plurality of entity profiles, an event topic, and the stored relationships between the plurality of entity profiles as input to generate, for an event associated with the event topic, one or more speaker scores, one or more attendee scores, and one or more affinity scores for the plurality of entity profiles; selecting, by the processor, a speaker and an attendee for the event based on the generated one or more speaker scores, the one or more attendee scores, and the one or more affinity scores; and generating, by the processor, a record comprising associations between identifications of the speaker, the attendee, and the event.

In another embodiment, a system comprises a server comprising a processor and a non-transitory computer-readable medium. The non-transitory computer-readable medium may contain instructions that when executed by the processor causes the processor to perform operations comprising receiving, from a plurality of data sources, clinical data regarding a plurality of medical entities; generating, from the clinical data, a plurality of entity profiles for the plurality medical entities and a network graph data structure comprising stored relationships between the plurality of entity profiles; executing a model using identifiers of the plurality of entity profiles, an event topic, and the stored relationships between the plurality of entity profiles as input to generate, for an event associated with the event topic, one or more speaker scores, one or more attendee scores, and one or more affinity scores for the plurality of entity profiles; selecting a speaker and an attendee for the event based on the generated one or more speaker scores, the one or more attendee scores, and the one or more affinity scores; and generating a record comprising associations between identifications of the speaker, the attendee, and the event.

### BRIEF DESCRIPTION OF THE DRAWING FIGURES

Objects, aspects, features, and advantages of embodiments disclosed herein will become more fully apparent from the following detailed description, the appended claims, and the accompanying drawing figures in which reference numerals identify similar or identical elements. Reference numerals that are introduced in the specification in association with a drawing figure may be repeated in one or more subsequent figures without additional description in the specification to provide context for other features, and not every element may be labeled in every figure. The drawing figures are not necessarily to scale, emphasis instead being placed upon illustrating embodiments, principles, and concepts. The drawings are not intended to limit the scope of the claims included herewith.

FIG. 1A is a block diagram of embodiments of a computing device;

FIG. 1B is a block diagram depicting a computing environment comprising client devices in communication with cloud service providers;

FIG. 2 is a block diagram of an example system in which event management services may manage and streamline access by clients to resource feeds (via one or more gateway services) and/or software-as-a-service (SaaS) applications;

FIG. 3 is an example computing environment for implementing a multi-model architecture for linking speaker and attendee entity profiles, in accordance with one or more implementations;

FIGS. 4A and 4B illustrate flowcharts of example methods for implementing a multi-model architecture for linking speaker and attendee entity profiles, in accordance with one or more implementations;

FIG. 5 illustrates a sequence for implementing a multi-model architecture for linking speaker and attendee entity profiles, in accordance with one or more implementations;

FIG. 6 illustrates another sequence for implementing a multi-model architecture for linking speaker and attendee entity profiles, in accordance with one or more implementations;

FIG. 7 illustrates a non-limiting example of a graphical user interface of an electronic platform enabling optimized speaker and attendee retrieval for an event, in accordance with one or more implementations; and

FIGS. 8A-F illustrate a non-limiting example of a data flow of a system implementing the systems and methods described herein, in accordance with one or more implementations.

The features and advantages of the present solution will become more apparent from the detailed description set forth below when taken in conjunction with the drawings, in which like reference characters identify corresponding elements throughout. In the drawings, reference numbers generally indicate identical, functionally similar, and/or structurally similar elements.

### DETAILED DESCRIPTION

Reference will now be made to the illustrative embodiments depicted in the drawings, and specific language will be used here to describe the same. It will nevertheless be understood that no limitation of the scope of the claims or this disclosure is thereby intended. Alterations and further modifications of the inventive features illustrated herein, and additional applications of the principles of the subject matter illustrated herein, which would occur to one skilled in the relevant art and having possession of this disclosure, are to be considered within the scope of the subject matter disclosed herein. Other embodiments may be used and/or other changes may be made without departing from the spirit or scope of the present disclosure. The illustrative embodiments described in the detailed description are not meant to be limiting of the subject matter presented.

Section A describes a computing environment that may be useful for practicing embodiments described herein;

Section B describes a non-limiting example of a multi-model speaker and attendee selection system architecture; and

Section C describes a non-limiting example of a method for implementing a multi-model system architecture to select optimal speakers and/or attendees for an event.

### Section A: Computing Environment

Prior to discussing the specifics of embodiments of the systems and methods of an appliance and/or client, it may be helpful to discuss the computing environments in which such embodiments may be deployed.

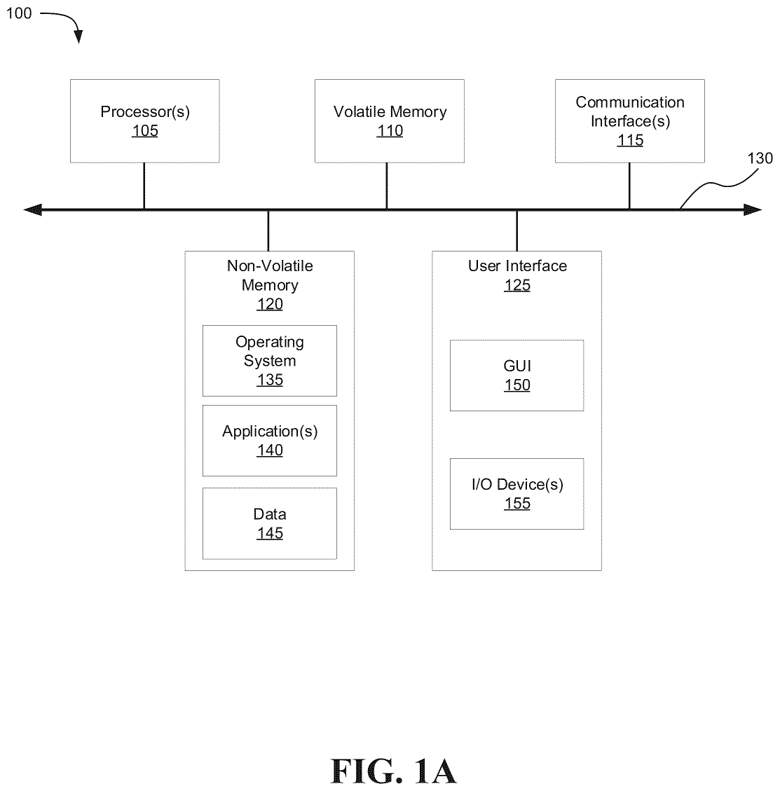

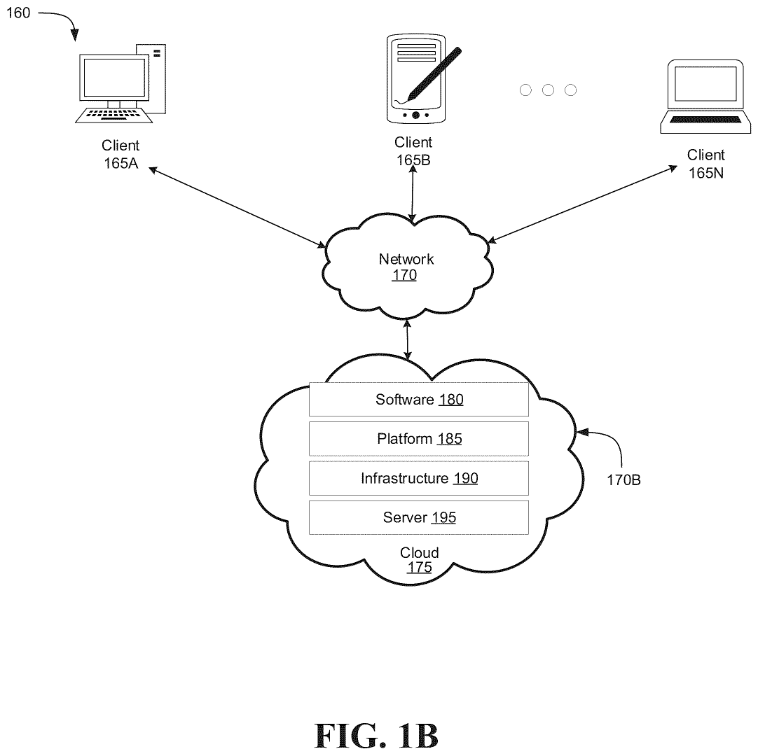

As shown in FIG. 1A, computer 100 may include one or more processors 105, volatile memory 110 (e.g., random access memory (RAM)), non-volatile memory 120 (e.g., one or more hard disk drives (HDDs) or other magnetic or optical storage media, one or more solid-state drives (SSDs) such as a flash drive or other solid-state storage media, one or more hybrid magnetic and solid-state drives, and/or one or more virtual storage volumes, such as cloud storage, or a combination of such physical storage volumes and virtual storage volumes or arrays thereof), a user interface (UI) 125, one or more communications interfaces 115, and a communication bus 130. User interface 125 may include a graphical user interface (GUI) 150 (e.g., a touchscreen, a display, etc.) and one or more input/output (I/O) devices 155 (e.g., a mouse, a keyboard, a microphone, one or more speakers, one or more cameras, one or more biometric scanners, one or more environmental sensors, one or more accelerometers, etc.). The non-volatile memory 120 stores operating system 135, one or more applications 140, and data 145 such that, for example, computer instructions of operating system 135 and/or applications 140 are executed by processor(s) 105 out of volatile memory 110. In some embodiments, volatile memory 110 may include one or more types of RAM and/or a cache memory that may offer a faster response time than the main memory. Data may be entered using an input device of GUI 150 or received from I/O device(s) 155. Various elements of computer 100 may communicate via one or more communication buses, shown as communication bus 130.

Computer 100 as shown in FIG. 1A is shown merely as an example, as clients, servers, intermediary, and other networking devices and may be implemented by any computing or processing environment and with any type of machine or set of machines that may have suitable hardware and/or software capable of operating as described herein. Processor(s) 105 may be implemented by one or more programmable processors to execute one or more executable instructions, such as a computer program, to perform the functions of the system. As used herein, the term “processor” describes circuitry that performs a function, an operation, or a sequence of operations. The function, operation, or sequence of operations may be hardcoded into the circuitry or soft coded by way of instructions held in a memory device and executed by the circuitry.

A “processor” may perform the function, operation, or sequence of operations using digital values and/or using analog signals. In some embodiments, the “processor” can be embodied in one or more application-specific integrated circuits (ASICs), microprocessors, digital signal processors (DSPs), graphics processing units (GPUs), microcontrollers, field-programmable gate arrays (FPGAs), programmable logic arrays (PLAs), multi-core processors, or general-purpose computers with associated memory. The “processor” may be analog, digital or mixed-signal. In some embodiments, the “processor” may be one or more physical processors or one or more “virtual” (e.g., remotely located or “cloud”) processors. A processor including multiple processor cores and/or multiple processors may provide functionality for parallel, simultaneous execution of instructions, or for parallel, simultaneous execution of one instruction on more than one piece of data.

Communications interfaces 115 may include one or more interfaces to enable computer 100 to access a computer network such as a Local Area Network (LAN), a Wide Area Network (WAN), a Personal Area Network (PAN), or the Internet through a variety of wired and/or wireless or cellular connections.

In described embodiments, the computing device 100 may execute an application on behalf of a user of a client computing device. For example, the computing device 100 may execute a virtual machine, which provides an execution session within which applications execute on behalf of a user or a client computing device, such as a hosted desktop session. The computing device 100 may also execute a terminal services session to provide a hosted desktop environment. The computing device 100 may provide access to a computing environment including one or more of one or more applications, one or more desktop applications, and one or more desktop sessions in which one or more applications may execute.

Referring to FIG. 1B, a computing environment 160 is depicted. Computing environment 160 may generally be implemented as a cloud computing environment, an on-premises (“on-prem”) computing environment, or a hybrid computing environment including one or more on-premises computing environments and one or more cloud computing environments. When implemented as a cloud computing environment, also referred to as a cloud environment, cloud computing, or cloud network, computing environment 160 can provide the delivery of shared services (e.g., computer services) and shared resources (e.g., computer resources) to multiple users. For example, the computing environment 160 can include an environment or system for providing or delivering access to a plurality of shared services and resources to a plurality of users through the internet. The shared resources and services can include but are not limited to, networks, network bandwidth, servers, processing, memory, storage, applications, virtual machines, databases, software, hardware, analytics, and intelligence.

In some embodiments, the computing environment 160 may provide client 165 with one or more resources provided by a network environment. The computing environment 160 may include one or more clients 165a-165n, in communication with a cloud 175 over one or more networks 170. The cloud 175 may include back-end platforms, e.g., servers, storage, server farms, or data centers. The clients 165 can be the same as or substantially similar to computer 100 of FIG. 1A.

The users or clients 165 can correspond to a single organization or multiple organizations. For example, the computing environment 160 can include a private cloud serving a single organization (e.g., enterprise cloud). The computing environment 160 can include a community cloud or public cloud serving multiple organizations. In some embodiments, the computing environment 160 can include a hybrid cloud that is a combination of a public cloud and a private cloud. For example, the cloud 175 may be public, private, or hybrid. Public clouds 175 may include public servers that are maintained by third parties to the clients 165 or the owners of the clients 165. The servers may be located off-site in remote geographical locations as disclosed above or otherwise. Public clouds 175 may be connected to the servers over a public network 170. Private clouds 175 may include private servers that are physically maintained by clients 165 or owners of clients 165. Private clouds 175 may be connected to the servers over a private network 170. Hybrid clouds 175 may include both the private and public networks 170 and servers.

The cloud 175 may include back-end platforms, e.g., servers, storage, server farms, or data centers. For example, the cloud 175 can include or correspond to a server or system remote from one or more clients 165 to provide third-party control over a pool of shared services and resources. The computing environment 160 can provide resource pooling to serve multiple users via clients 165 through a multi-tenant environment or multi-tenant model with different physical and virtual resources dynamically assigned and reassigned responsive to different demands within the respective environment. The multi-tenant environment can include a system or architecture that can provide a single instance of the software, an application, or a software application to serve multiple users. In some embodiments, the computing environment 160 can provide on-demand self-service to unilaterally provision computing capabilities (e.g., server time, network storage) across a network for multiple clients 165. The computing environment 160 can provide elasticity to dynamically scale out or scale in responsive to different demands from one or more clients 165. In some embodiments, the computing environment 160 can include or provide monitoring services to monitor, control, and/or generate reports corresponding to the provided shared services and resources.

In some embodiments, the computing environment 160 can include and provide different types of cloud computing services. For example, the computing environment 160 can include Infrastructure as a Service (IaaS). The computing environment 160 can include Platform as a Service (PaaS). The computing environment 160 can include server-less computing. The computing environment 160 can include Software as a Service (SaaS). For example, the cloud 175 may also include a cloud-based delivery, e.g., Software as a Service (SaaS) 180, Platform as a Service (PaaS) 185, and Infrastructure as a Service (IaaS) 190. IaaS may refer to a user renting the use of infrastructure resources that are needed during a specified time period. IaaS providers may offer storage, networking, servers, or virtualization resources from large pools, allowing the users to quickly scale up by accessing more resources as needed. Examples of IaaS include AMAZON WEB SERVICES provided by Amazon.com, Inc., of Seattle, Washington; RACKSPACE CLOUD provided by Rackspace US, Inc., of San Antonio, Texas; Google Compute Engine provided by Google Inc. of Mountain View, California; or RIGHTSCALE provided by RightScale, Inc., of Santa Barbara, California. PaaS providers may offer functionality provided by IaaS, including, e.g., storage, networking, servers, or virtualization, as well as additional resources such as, e.g., the operating system, middleware, or runtime resources. Examples of PaaS include WINDOWS AZURE provided by Microsoft Corporation of Redmond, Washington; Google App Engine provided by Google Inc.; and HEROKU provided by Heroku, Inc., of San Francisco, California. SaaS providers may offer the resources that PaaS provides, including storage, networking, servers, virtualization, operating system, middleware, or runtime resources. In some embodiments, SaaS providers may offer additional resources including, e.g., data and application resources. Examples of SaaS include GOOGLE APPS provided by Google Inc.; SALESFORCE provided by Salesforce.com Inc. of San Francisco, California; or OFFICE 365 provided by Microsoft Corporation. Examples of SaaS may also include data storage providers, e.g., DROPBOX provided by Dropbox, Inc., of San Francisco, California; Microsoft SKYDRIVE provided by Microsoft Corporation; Google Drive provided by Google Inc.; or Apple ICLOUD provided by Apple Inc. of Cupertino, California.

Clients 165 may access IaaS resources with one or more IaaS standards, including, e.g., Amazon Elastic Compute Cloud (EC2), Open Cloud Computing Interface (OCCI), Cloud Infrastructure Management Interface (CIMI), or OpenStack standards. Some IaaS standards may allow clients access to resources over HTTP and may use Representational State Transfer (REST) protocol or Simple Object Access Protocol (SOAP). Clients 165 may access PaaS resources with different PaaS interfaces. Some PaaS interfaces use HTTP packages, standard Java APIs, JavaMail API, Java Data Objects (JDO), Java Persistence API (JPA), Python APIs, web integration APIs for different programming languages including, e.g., Rack for Ruby, WSGI for Python, or PSGI for Perl, or other APIs that may be built on REST, HTTP, XML, or other protocols. Clients 165 may access SaaS resources through the use of web-based user interfaces, provided by a web browser (e.g., GOOGLE CHROME, Microsoft INTERNET EXPLORER, or Mozilla Firefox provided by Mozilla Foundation of Mountain View, California). Clients 165 may also access SaaS resources through smartphone or tablet applications, including, e.g., Salesforce Sales Cloud or Google Drive app. Clients 165 may also access SaaS resources through the client operating system, including, e.g., Windows file system for DROPBOX.

In some embodiments, access to IaaS, PaaS, or SaaS resources may be authenticated. For example, a server or authentication server may authenticate a user via security certificates, HTTPS, or API keys. API keys may include various encryption standards such as e.g., Advanced Encryption Standard (AES). Data resources may be sent over Transport Layer Security (TLS) or Secure Sockets Layer (SSL).

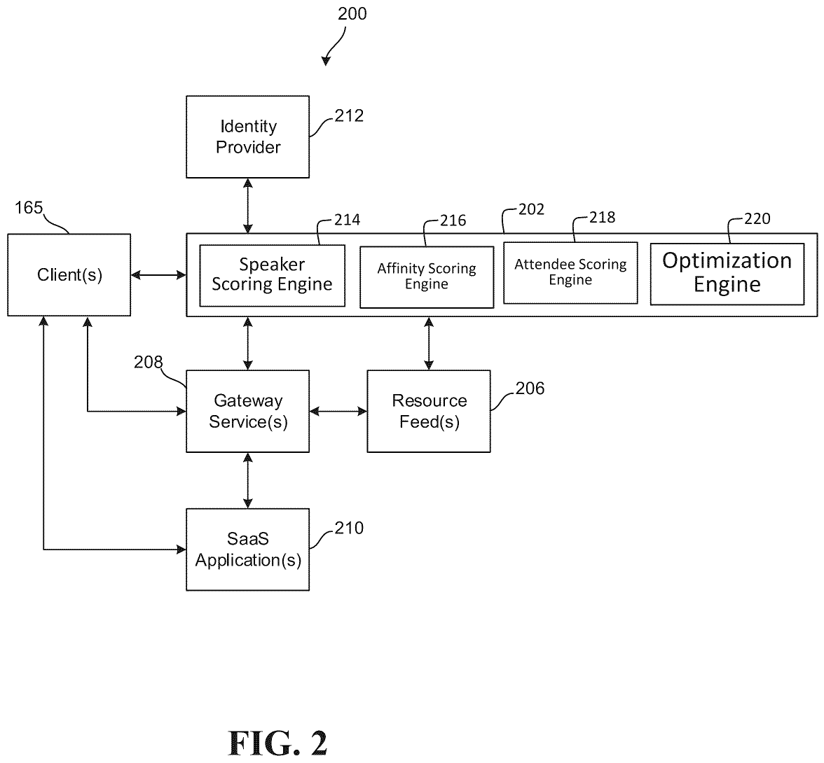

FIG. 2 is a block diagram of an example system 200 in which an event optimization engine 202 may generate an interactive electronic platform on a user interface and transmit the user interface to the clients 165. Users of the clients 165 may access the interactive electronic platform and input different attributes of an upcoming event for which they are identifying optimal speakers and/or attendees. The event optimization engine 202 may receive the input attributes and receive data from resource feeds 206 that provide clinical data regarding different medical entities. The event optimization engine 202 may feed the attributes and clinical data through a speaker scoring engine 214 (e.g., one or more machine learning models) for the medical entities to operate in tandem to generate speaker or influence scores. The event optimization engine 202 may feed the attributes and clinical data through an affinity scoring engine 216 to generate affinity score for the medical entities indicating the degree of closeness of relationship with the rest of the medical entities. The event optimization engine 202 may also feed the attributes and clinical data through an attendee scoring engine 218 to generate attendee scores for the medical entities indicating a likelihood that the attendees will attend the event. The event optimization engine 202 may then feed the speaker scores and the attendee scores into an optimization engine 220 with other data (e.g., geographical data) to generate an output of recommended speakers and/or attendees for the event.

In one example, the event optimization engine 202 may employ an identity provider 212 to authenticate the identity of a user of a client 165 and, following authentication, grant the user access to the interactive electronic platform. Via the access, client 165 may input attributes associated with an event. The event optimization engine 202 may receive the input and execute a series of models (e.g., machine learning models and optimization models) in the speaker scoring engine 214, the affinity scoring engine 216, the attendee scoring engine 218, and the optimization engine 220. In some implementations, the client 165 may communicate with the event optimization engine 202 via gateway services 208. In some implementations, the client 165 may access the event optimization engine 202 directly through SaaS application(s) 210. The SaaS application(s) 210 may allow the client 165 to access the electronic platform discussed herein.

The client(s) 165 may be any type of computing device capable of accessing the resource feeds 206 and/or the SaaS applications 210, and may, for example, include a variety of desktop or laptop computers, smartphones, tablets, etc. Each of the event optimization engine 202, the resource feeds 206, the gateway services 208, the SaaS applications 210, and the identity provider 212 may be located within an on-premises data center of an organization for which the system 200 is deployed, within one or more cloud computing environments, or elsewhere.

### Section B: Event Optimization System

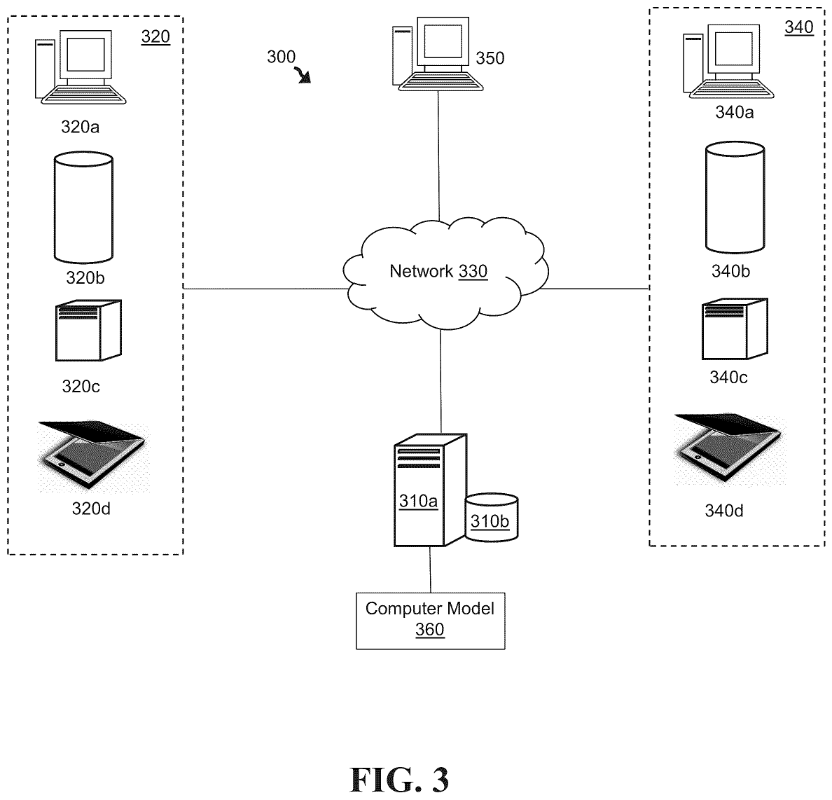

As will be described throughout, a server of an event optimization system 300 (such as an analytics server 310a) can retrieve and analyze data using various methods described herein to select speakers and/or attendees for an event using a series of models (e.g., machine learning models). In doing so, the server may optimize the attendance and/or the engagement at events. FIG. 3 is a non-limiting example of components of the event optimization system 300 in which the analytics server 310a operates. The analytics server 310a may be any computer, server, or processor described in FIGS. 1A-2.

As described herein, an event may be a speaking engagement in which a medical entity speaks (e.g., a speaker) to other medical entities at the event (e.g., attendees). Examples of events are conferences, training programs, or any other event that involve a speaker speaking to an audience. Events may include any number of speakers and/or attendees. Such events may be associated with different attributes such as an event type (e.g., virtual or in-person), an event location, an event topic, an event size, an event format, etc.

The analytics server 310a may utilize components described in FIG. 3 to retrieve data and to generate/display results. The analytics server 310a may be communicatively coupled to a system database 310b, electronic data sources 320a-d (collectively electronic data sources 320), end-user devices 340a-d (collectively end-user devices 340), and/or an administrator computing device 350. The system 300 is not confined to the components described herein and may include additional or alternative components, not shown for brevity, which is to be considered within the scope of the embodiments described herein.

The above-mentioned components may be connected through a network 330. The examples of the network 330 may include, but are not limited to, private or public LAN, WLAN, MAN, WAN, and the Internet. The network 330 may include both wired and wireless communications according to one or more standards and/or via one or more transport mediums.

The analytics server 310a may utilize one or more application programming interfaces (APIs) to communicate with one or more of the electronic devices described herein. For instance, the analytics server may utilize application programming interfaces (APIs) to automatically receive data from the electronic data sources 320. The analytics server 310a can receive data as it is generated, monitored, and/or processed by the respective electronic data source 320. For instance, the analytics server 310a may utilize an API to receive clinical data from the database 320b without any human intervention. This automatic communication allows for faster retrieval and processing of data.

As described herein, clinical data is data that is descriptive or otherwise associated with a medical field, a medical topic, a medical professional (e.g., a doctor, nurse, or social worker), and/or a healthcare provider. Examples of clinical data include, but are not limited to social media data, competitive engagement data, data from congress, clinical trial data, publication data, real-world data (data that captures the physician's role in providing clinical care such as prescribing, diagnosing, treating data from insurance claims data and electronic medical records), channel affinity data, speaker bureau customer master affiliation data and engagement data, etc. The clinical data may be associated with medical entities if the medical entities were involved in generating the clinical data (e.g., the medical entity authored or co-authored a publication, the medical entity posted the message on a social media website, the medical entity performed a clinical trial and uploaded the data for the clinical trial, the medical entity received a message, etc.). In some implementations, to establish the association between an entity and clinical data, the analytics server may receive the clinical data and scan (e.g., optical character recognition (OCR)) the clinical data to determine if there is a string that matches a medical entity's name. If there is a match, the data processing system may label the data or an entity profile associated with the medical entity to indicate the clinical data is associated with the medical entity.

The analytics server 310a may generate and/or host an electronic platform having a series of graphical user interfaces (GUIs) configured to use various computer models to project and display data associated with an event. The electronic platform can be displayed on the electronic data sources 320, the administrator computing device 350, and/or end-user devices 340. An example of the electronic platform generated and/or hosted by the analytics server 310a may be a web-based application or a website configured to be displayed on different electronic devices, such as mobile devices, tablets, personal computers, and the like. Even though certain embodiments discuss the analytics server 310a displaying the results, it is expressly understood that the analytics server 310a may either directly generate and display the electronic platform described herein or may present the data to be presented on a GUI displayed on the end-user devices 340.

The analytics server 310a may host a website (also referred to herein as the electronic platform) accessible to users operating any of the electronic devices described herein (e.g., end-users). In some implementations, the content presented via the various webpages may be controlled based upon each particular user's role or viewing permissions. The analytics server 310a may be any computing device comprising a processor and non-transitory machine-readable storage capable of executing the various tasks and processes described herein. Non-limiting examples of such computing devices may include servers, computers, workstation computers, personal computers, and the like. While this example of the system 300 includes a single analytics server 310a, in some configurations, the analytics server 310a may include any number of computing devices operating in a distributed computing environment.

The analytics server 310a may execute one or more software applications configured to display the electronic platform (e.g., host a website), which may generate and serve various webpages to end-user devices 340. Different end-users may use the website to view and/or interact with the predicted results.

The analytics server 310a may be configured to require user authentication based upon a set of user authorization credentials (e.g., username, password, biometrics, cryptographic certificate, and the like). In such implementations, the analytics server 310a may access the system database 310b configured to store user credentials, which the analytics server 310a may be configured to reference to determine whether a set of entered credentials (purportedly authenticating the user) match an appropriate set of credentials that identify and authenticate the user.

The analytics server 310a may also store data associated with each user operating one or more electronic data sources 320 and/or end-user devices 340. The analytics server 310a may use the data to determine whether a user device is authorized to view results generated by the computer model(s) discussed herein, such as a computer model 360.

The computer model 360 may be any collection of one or more algorithms and/or machine-readable code that can ingest medical data and/or connection data associated with a medical entity to select one or more speakers and/or one or more attendees. The computer model 360 may include a mathematical algorithm, an optimization algorithm (e.g., Technique for Order of Preference by Similarity to Ideal Solution (TOPSIS) such as Multi-Criteria Decision Making (MCDM) TOPSIS) an artificial intelligence or machine learning model (e.g., neural network) that can be trained in accordance with data received from the electronic data sources 320 and/or end-user devices 340. In some implementations, the analytics server 310 may use the data collected from the electronic data sources 320 to generate a training dataset and further train the computer model 360 using various machine learning techniques (e.g., supervised, unsupervised, or semi-supervised training).

The analytics server 310a may receive clinical data from end-user devices 340 and/or electronic data sources 320. The electronic data sources 320 may represent different databases or third-party vendors who possess medical data, marketing data, clinical trial data, and the like. For instance, the electronic data sources 320 may represent computers, databases, and servers of a medical provider that can provide additional information regarding a clinical trial. In some implementations, the analytics server 310a may scrape social media websites (which may be hosted by electronic data sources 320) to retrieve data from the websites such as connection data (e.g., data indicating the medical entities are connected with each other through the websites), comments, blog posts, likes, and/or any other type of interaction.

The analytics server 310a may use the data collected from the electronic data sources 320 and received from the end-user device 340 to execute the computer model 360. The analytics server 310a then displays the results via the electronic platform (e.g., GUIs) on the administrator computing device 350 or the end-user devices 340.

The end-user devices 340 may be any computing device comprising a processor and a non-transitory machine-readable storage medium capable of performing the various tasks and processes described herein. Non-limiting examples of an end-user device may include workstation computers, laptop computers, tablet computers, and server computers. In operation, various end-users may use end-user devices 340 to access the electronic platform operationally managed by the analytics server 310a to enter event attributes and view predicted optimal speakers and/or attendees for events.

The administrator computing device 350 may represent a computing device operated by a system administrator. The administrator computing device 350 may be configured to display retrieved data, in the form of results generated by the analytics server 110a, where the system administrator can monitor various models utilized by the analytics server 110a, review feedback, and modify various thresholds/rules described herein.

The analytics server 310a may access, generate, and execute various computer models. Although the example system 300 depicts the computer model 360 stored on the analytics server 310a, the model 360 may be stored on another device or server (e.g., stored locally or in cloud storage).

In operation, the analytics server 310a may collect various types of clinical data and/or about, generated by, or otherwise associated with different medical entities. The analytics server 310a may then train the one or more models of the computer model 360 to develop an algorithm to calculate speaker and/or attendee scores and an optimization algorithm to optimize the speakers and/or attendees that attend an event. When the computer model 360 is trained, the analytics server 310 may implement the computer model, and allow end-users to use the computer model 360 to view the optimal speakers and/or attendees for the event. For instance, an end-user may use any of the end-user devices 340 to access the electronic platform and enter attributes of an event. The analytics server 310a may then execute the computer model 360 to select optimal speakers and/or attendees. The analytics server 310a may generate a record comprising strings identifying the speakers, attendees, and/or the event and populate the electronic platform with the record.

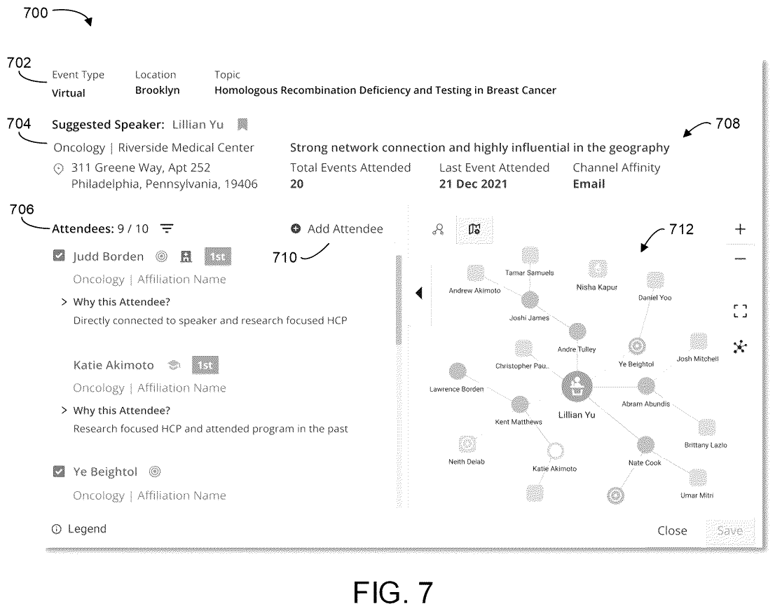

The electronic platform may include various GUIs discussed herein where each GUI may include various input elements allowing the end-user to input attributes of an event and see an optimized list of attendees and/or speakers based on the input elements. An example of such a GUI presented within the electronic platform is shown and described with respect to FIG. 7.

### Section C: Event Optimization Method

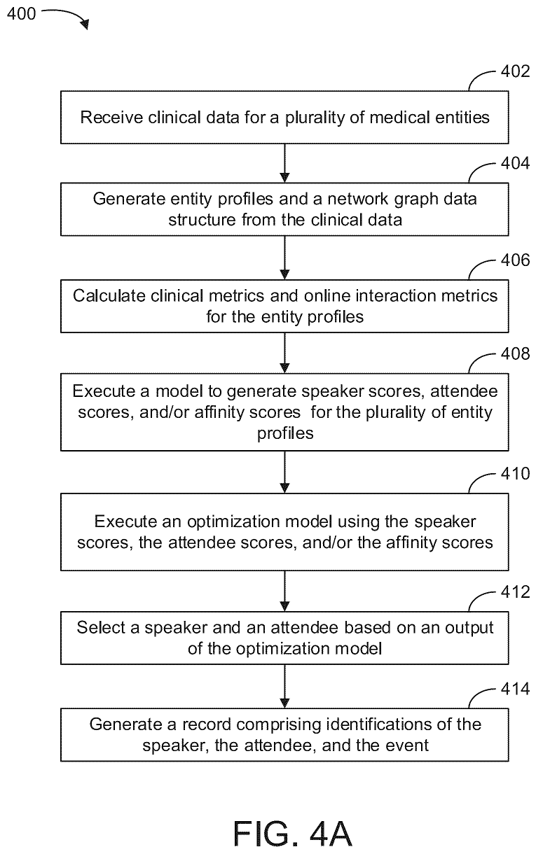

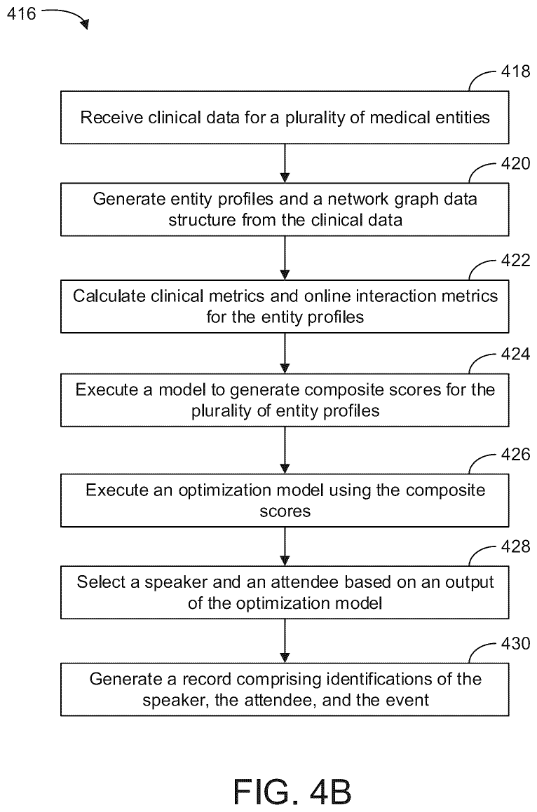

Referring now to FIG. 4A, a flowchart of an example method 400 for implementing a multi-model architecture for linking speaker and attendee entity profiles is shown, in accordance with one or more implementations. The method 400 may be performed by a data processing system (e.g., the event optimization engine 202, the analytics server 310a, a client device 165, or any other computing device). The method 400 may include any number of steps and the steps may be performed in any order. Performance of the method 400 may enable the data processing system to use a series of models to automatically link speakers and attendees to events to optimize engagement at the events. By performing the method 400, the data processing system may link attendees and speakers to events without relying on any human guessing or analysis on an event-by-event basis, as is often done in conventional systems.

At step 402, the data processing system may receive clinical data for a plurality of medical entities. As described herein, medical entities may be or include any medical professional or other healthcare providers. The data processing system may receive multiple different types of clinical data and receive the clinical data from different sources. For example, the data processing system may receive social media data (e.g., data from a server that hosts social media websites, which may include any website that allows users to communicate with other users, including through comments, direct messages, posts, blog posts, relationships, etc.), competitive engagement data, data from congress, clinical trial data, publication data, real-world data, channel affinity data, speaker bureau customer master affiliation data and engagement data, etc. In one example, the clinical data may be or include publications authored or co-authored by the individual medical entities. The medical data may include text and/or images describing different medical fields such as new procedures, medical inventions, diseases, diagnosis techniques, etc.

The data processing system may receive the clinical data through different methods, depending on the data source. In one example, the data processing system may simply receive clinical data from a data source after the data source transmitted the clinical data to the data processing system. Such may be the case, for example, when the data processing system has a pre-existing relationship (e.g., an established connection) with the data source and the data source is configured to transmit new clinical data to the data processing system either upon receipt, upon a defined time interval passing, or upon receipt of a request for the clinical data from the data processing system. In another example, the data processing system may use web-scraping techniques to retrieve data from various web pages. To do so, the data processing system may retrieve data from the servers or computers hosting the website after identifying the clinical data and the medical entities that are associated with (e.g., named in) the clinical data. Such may be the case when the data processing system retrieves data from social media websites.

At operation 404, the data processing system may generate entity profiles and a network graph data structure. The data processing system may generate the entity profiles and the network graph data structure from the received clinical data. Entity profiles may be data structures that include medical entities' names, demographic information about the medical entities, and/or any clinical data the data processing system has stored in the respective entity profiles. In some implementations, the data processing system may store pointers to the location of clinical data in the entity profiles, thus conserving memory resources by avoiding storing duplicative copies of clinical data locally when the data can be accessed and retrieved from another host computing device or database. Each profile may include a string identification of the entity that is associated with the profile and/or a unique identifier the data processing system generates (e.g., generates using a pseudo-random number generator). The data processing system may use such identifications to link or insert new clinical data into the respective profiles and/or to group the entity profiles together for fast retrieval.

To generate the entity profiles, the data processing system may implement various matching techniques (e.g., exact matching or fuzzy matching) between strings in data files or data packets in the clinical data and strings in the individual profiles. For example, the data processing system may identify and/or extract a name of an author from a publication from a particular field the data processing system may be trained to query, or from text the data processing system identified using natural language processing techniques (NLP). The data processing system may identify either exact matches (e.g., matching strings in which each character matches) or fuzzy matches (e.g., matching strings that do not have the exact same characters, but are similar above a defined threshold percentage or number of characters) between the identified strings of names in the clinical data and the different entity profiles. In some implementations, the data processing system may identify fuzzy matches based on a comparison between the strings and/or using an edit distance algorithm. Upon identifying a match between a file or data packet of clinical data and an entity profile, the data processing system may store the file or data packet in the matching entity profile.

In some cases, the data processing system may identify a name in the clinical data that does not match names in any profiles of the network data structure. When this occurs, the data processing system may “enrich” the network data structure and generate a new data structure for a new profile containing the name. After generating the new profile, the data processing system may perform the same updating steps as listed above to update the profile with clinical data associated with the name.

The data processing system may generate the network graph data structure with the entity profiles. To do so, the data processing system may generate edges or connections between entity profiles that are connected or have a relationship in some manner. For example, when the data processing system identifies a data file or a data packet with multiple names (e.g., a publication with co-authors), the data processing system may identify the entity profiles that match each name. Additionally, because the data processing system identified the names from the same data file or data packet, the data processing system may determine the entity profiles have at least some sort of relationship with each other. Accordingly, the data processing system may generate an edge or connection between the two entity profiles. In another example, the data processing system may determine entity profiles have connections responsive to identifying posts by one medical entity on a social media page of another medical entity. The post may indicate the two medical entities are related, and therefore cause the data processing system to generate an edge between the two profiles. In yet another example, the data processing system may generate an edge between two entity profiles that participated in a clinical experiment together. In yet another example, the data processing system may generate edges between entity profiles for working at the same company (e.g., in the same hospital), in which case the data processing system may determine the entities work at the same company by analyzing a human resources form or scraping a company web page indicating the company's employees. In yet another example, the data processing system may identify a common patient from healthcare forms of two different medical entities and generate an edge between the medical entities based on the identification. The data processing system may generate edges between entity profiles for any similar reasons.

In some implementations, to generate the edges between entity profiles, the data processing system may insert pointers into both entity profiles. The pointers may point to the other entity profile connected to the edge. The pointers may be selectable addresses to quickly access data of the other entity profile or otherwise an identification of the other entity profile to indicate there is an edge between the two entity profiles.

In some implementations, in addition to the pointers, the data processing system may calculate a distance score for each of the edges. The data processing system may calculate the distance score as a function of the affinity score of the connection and/or whether the connection is direct. The affinity score may indicate a degree of closeness of the relationship. The data processing system may calculate the affinity score using a set of affinity rules that indicate the basis on which to evaluate the affinity of individual connections between medical entities. For example, the set of affinity rules may include a rule that indicates being employed by the same company would result in a high affinity score. In yet another example, the set of affinity rules may include indicating sharing a patient results in a high closeness. In some implementations, the data processing system may use such rules in combination with Dijkstra's algorithm to calculate the affinity score. The set of affinity rules may include any number and/or type of such rules.

In some implementations, the data processing system may determine the degree of connection as being a direct or an indirect connection (e.g. second degree connection, third degree connection etc.). To do so, the data processing system may identify how the connection was created (e.g., the type of data file or data packet that resulted in the generation of the connection) and determine whether the connection is a direct connection or not according to a set of connection rules (e.g., a connection resulting from a message between the two entities may be a direct connection). In one example, the data processing system may determine whether a connection is direct by determining if the entities associated with the entity profiles have communicated directly with each other (e.g., have transmitted social media messages to each other, have co-authored a publication together, etc.).

Upon determining the affinity score of a connection and whether the connection is a direct connection or an indirect connection, the data processing system may calculate a distance score for the connection. The data processing system may calculate the distance score using any function, such as an average, a sum, a weighted average, a weighted sum, a multiplier (e.g., a direct connection may be associated with one value and a second degree connection may be associated with another value; the value may be multiplied by the corresponding closeness score to obtain the affinity score), etc. Any function may be used to calculate the distance score for the connection.

The data processing system may store one or more of the type of the degree of connection, the distance score of the connection, or the affinity score of the connection in one or both of the connected profiles. In this way, the data processing system may later retrieve the stored data to insert into a machine learning model and/or an optimization algorithm to select the optimal speakers and/or attendees for an event and/or to present the stored data to a user on a user interface.

At operation 406, the data processing system may calculate clinical metrics for the entity profiles. The data processing system may calculate the clinical metrics and/or separately evaluate different types of clinical data. For instance, in some implementations, the data processing system may maintain one or more counters for each of the different types of clinical data. The counts of the counters may be clinical metrics. In one example, the data processing system may maintain and increment a counter for an individual for each publication the individual authored or co-authored. Each instance in which the data processing system identifies the individual's name as an author of a different publication, the data processing system may increment the counter. In another example, the data processing system may maintain a counter for the number of posts an individual has made on a single or multiple social media sites (e.g., maintain a separate counter for each social media site or a single counter for all social media sites with which the individual has interacted). The data processing system may scrape the data from the social media sites and increment the counter for each post the individual made on the sites. The data processing system may maintain and increment such counters for any number of types of clinical data. Other examples of counters for different types of clinical data the data processing system may maintain are below:

1. COMMERCIAL FEATURES: total_number_of_patients,,
total_number_of_treated_patients, tot_diagnosed_pat_count, tot_drug_pat_count,
tot_procedure_pat_count
2. PUBLICATION FEATURES: number_of_publications,
number_of_therapy_related_publications, latest_pub_title,
number_of_case_report_publications, number_of_publications_as_first_author
3. CLINICAL TRIAL FEATURES: number_of_clinical_trials,
number_of_ongoing_clinical_trials, number_of_therapy_related_clinical_trials,
avg_identified_sites, number_of_academic_sponsored_clinical_trials, latest_clinical_trl_title,
number_of_clinical_trials_us, number_of_industry_sponsored_clinical_trials
4. CONGRESS ABSTRACT FEATURES: number_of_congress_abstract,
number_of_therapy_related_congress_abstract, latest_cngrss_abstract_date
5. SOCIAL MEDIA FEATURES: number_of_followers, number_of posts,
number_of_retweeted_hcps, last_post_date, number_of_shares, twitter_verified
6. OPEN PAYMENT FEATURES: research_payment, speaking_payment,
consulting_payment, food_and_beverage_payment, associate_research_payment,
total_open_payment_amount, top_brand
7. CONNECTION FEATURES: number_of_referral_connections,
number_of_publication_connections, number_of_clinical_trial_connections,
number_of_congress_connections, no_of_total_connections
8. DESK RESEARCH FEATURES: total_number_of_engagements

The data processing system may calculate such metrics and, in some implementations, store the metrics in the entity profiles of the medical entities that correspond to the calculated metrics.

At operation 408, the data processing system may execute a model to generate speaker scores, attendee scores, and/or affinity scores for the plurality of entity profiles. A speaker score may indicate a degree of influence the speaker may have, and therefore how important potential attendees would deem attending an event in which the medical entity was speaking. An attendee score may indicate the likelihood that a medical entity will attend an event. An affinity score may indicate a degree of closeness of the relationship between the speaker and the attendee.

The model may be or include one or more machine learning models and/or optimization models. In one implementation, the data processing system may execute the model by executing a TOPSIS algorithm (e.g., an MCDM TOPSIS algorithm) that is configured to output a speaker score for a medical entity based on clinical metrics calculated for the medical entity. To do so, the data processing system may set weights and impacts for the different clinical metrics by retrieving the weights and impacts from memory. The data processing system may then input the metrics into the TOPSIS algorithm and the TOPSIS algorithm may apply the weights and impacts to the metrics respectively to generate a speaker score for the entity profile associated with the medical entity.

In some implementations, the data processing system may generate speaker scores for each or a subset of the entity profiles of the network graph data structure. The data processing system may retrieve clinical data from their respective profiles and calculate metrics from the retrieved data. The data processing system may then separately input the calculated metrics into the TOPSIS algorithm to generate speaker scores for the medical entities. The data processing system may compare the generated speaker scores and generate a ranking list of the speakers in ascending or descending order based on the speaker scores compared with each other.

In some implementations, the data processing system may retrieve the weights and/or impacts for the TOPSIS algorithm based on the source of a request to select the optimal speaker and/or attendees. For example, different group entities (e.g., companies) may value different types of clinical data differently, and therefore prefer different weights and/or impacts from each other. Upon receiving a request for an optimal speaker and/or attendee or set of attendees, the data processing system may identify the group entity that is associated with the request from at least one of an identifier of the group entity in the request, the user profile of the individual that submitted the request, or a device identifier (e.g., an IP address of the computing device that submitted the request). The data processing system may identify the group entity and use a look-up technique in memory to identify the weights and/or impacts that are stored in an entity profile data structure for the group entity to use to execute the TOPSIS algorithm

In some implementations, the data processing system may use machine learning techniques to identify the proper weights or parameters for the TOPSIS algorithm. For example, the data processing system may execute a machine learning model (e.g., a support vector machine, a neural network, a random forest, etc.) to predict weights and/or features for the TOPSIS algorithm. The data processing system may feed training data (e.g., clinical metrics) into the TOPSIS algorithm and the TOPSIS algorithm may output a speaker score based on the training data. A user may submit or provide an input indicating whether the speaker score is correct and/or the correct speaker score. The data processing system may feed the input back into the machine learning model that calculated the weights and/or impacts for the TOPSIS algorithm for training. The machine learning model may use back-propagation techniques on its own weights and parameters for training for each iteration of training until the machine learning model predicts the proper weights and/or impacts for the TOPSIS algorithm to an accuracy above a defined accuracy threshold. In this way, the data processing system may determine the proper weights for the TOPSIS algorithm to accurately predict speaker scores for medical entities.

The data processing system may execute the model by executing a machine learning model that is configured to predict the probability that a medical entity will attend an event. In one implementation, the data processing system may execute the model by executing a gradient boosting decision tree algorithm (e.g., XGBoost) or any other machine learning algorithm that is configured to output attendance probability for a medical entity based on historical event attendance data. To do so, the data processing system may retrieve data from a database that indicates whether the medical entity attended an event and other information or attributes about the event (e.g., the event's geographic location, the event's topic, the number of people attending the event, the time and/or day of the week of the event, the length of the event, etc.). The data processing system may input the historical event attendance data including the attributes into the machine learning model for the medical entity and the machine learning model may generate an output attendee score predicting a likelihood the medical entity will attend the event. The data processing system may similarly generate attendee scores for any number of medical entities.

In some implementations, the data processing system may input received attributes about a medical entity into the model with the historical event-attendee data. For instance, the data processing system may receive a request for optimal attendees and an optimal speaker that includes attributes for the event, such as an event topic and/or a geographic location. The data processing system may identify the event topic and/or the geographic location from the request and concatenate the topic and/or geographic location (or numerical values representing the topic and/or location) with the historical event-attendee data into a feature vector and input the feature vector into the machine learning model. The machine learning model may then predict the attendee score for the medical entity based on the attributes for the event identified in the request. By doing so, the data processing system may calculate an attendance score that is likely more accurate because different medical entities may be more or less likely to attend events based on the events' attributes.

In some implementations, the data processing system may generate program-specific features or metrics. Program-specific features may be features that are related to a requested topic for an event or a series of events, such as a series of events within a given time period. For instance, the data processing system may receive a request for optimal attendees and an optimal speaker that includes an event topic. The data processing system may identify or calculate features or metrics for medical entities that are specific to the requested event topic from the clinical data. Examples of such features or metrics include the number of publications the medical entity has authored that is related to the topic (which the data processing system may determine using NLP techniques), the number of events the medical entity has attended related to the topic, the medical entity's title and/or department within a company, etc. Other examples of counters for different types of clinical data the data processing system may maintain for event topics are below:
1. p_calls (the total number of calls made to individuals in the past n days for a particular program),
2. p_samples (the total number of samples dropped to individuals in the past n days for a particular program),
3. att_recency (minimum value of difference between program_date and last time event was attended by the medical entity),
4. samples_recency (minimum value of days when the samples were last dropped to the individual), and
5. calls_recency (minimum value of days when the call was last made to the individual).

The data processing system may calculate such program-specific features or metrics and input the program-specific features or metrics into the model to use to calculate the speaker score and/or the attendee score for a medical entity. In some implementations, the data processing system may do so by concatenating the program-specific features with one or both of the vectors that are fed into the models to calculate the speaker scores and/or the attendee scores. Thus, the data processing system may include data that is specific to the requested event to calculate the speaker score and/or attendee score to be more accurate and specific to the event.

At operation 410, the data processing system can execute an optimization model using the speaker scores, the attendee scores, and/or the affinity scores. In some implementations, the data processing system may execute the optimization model by executing a mixed-integer programming model or another type of optimization model (e.g., a linear programming model, a nonlinear programming model, a constraint programming model, etc.). The data processing system may input the speaker scores, the attendee scores, and/or the affinity scores for the different medical entities into the optimization model and execute the optimization model. In some implementations, the data processing system may also input the determined degrees of connections into the optimization model. By doing so, in some implementations, the data processing system may generate a series of values on a graph for potential speakers and/or attendees. From the series of values, the data processing system may identify the speakers and/or attendees that optimize an objective function according to the optimization model.

In some implementations, the data processing system may filter out medical entities from being considered to be a speaker and/or an attendee for an event. The data processing system may do so prior to calculating the speaker attendee scores and/or prior to executing the optimization model to avoid using processing resources to perform calculations for entity profiles that would not be selected. The data processing system may filter out the medical entities according to a set of attendance rules. Examples of such rules are below:
1. Attendees wouldn't be recommended for a given topic if the attendees have attended a prior event of the same topic, in some cases within a defined time period,
2. Regardless of topic, an attendee can only attend a number of programs below a threshold within a moving time window,
3. Product sales may not be used as indicators to recommend speakers or attendees for speaker programs,
4. Trained speakers shouldn't be recommended to be attendees for speaker programs of the same topic, and
5. Speakers should be assigned to present only on the topics for which they are trained.
   If data from an entity profile or other clinical data for a medical entity indicates one of such attendance rules is violated, the data processing system may remove the entity profile for the medical entity from the dataset being used to generate speakers scores and/or attendee scores.

To determine if one of the attendance rules is violated for a medical entity, the data processing system may evaluate data (e.g., historical attendance data) that is in or that is otherwise associated with the entity profile for the medical entity. For example, the data processing system may determine if a medical entity has attended an event on the same topic with a time period by scanning events the entity has attended and the topic of the events. If the scanning results in the data processing system identifying an event that has the same topic as a requested event, may filter out the attendee from consideration as an attendee for the event. In some implementations, instead of immediately filtering out the attendee, the data processing system may identify the time of the event and compare the time to a defined time period (e.g., determine whether the event occurred within the last month). If the event is outside of the defined time period, the data processing system may not filter out the attendee. If the event is inside the defined time period, the data processing system may filter out the attendee. In doing so, the data processing system may organize the entity profiles for medical entities into separate sets, one set of medical entities that recently attended an event (e.g., an event of the same topic), and another set of medical entities that have not. For instance, the data processing system can identify a first set of entity profiles of the network graph data structure comprising first historical attendance data indicating entities that have previously attended an event associated with the event topic and a second set of entity profiles of the network graph data structure comprising second historical attendance data indicating entities that have not previously attended any events associated with the event topic. The data processing system may execute the model and/or the optimization model using only the set of entity profiles for medical entities that have not attended an event having the same topic as the requested event. Thus, the data processing system may ensure an attendee is not invited to attend an event on the same topic too recently, increasing the chances the invited attendees will attend the event.

In one example, the data processing system may filter out attendees that are located (e.g., live) too far away from a speaker's location or an event location. For instance, the data processing system may receive a first geographic location for an event. The data processing system may extract the geographic locations of various medical entities from their entity profiles. The data processing system may then calculate a distance between the extracted locations of the medical entities and the first geographic location for the event such as by using a map application, for example. The data processing system may identify entity profiles of medical entities that are located within a distance threshold of the first geographic location of the event and disregard or discard (e.g., remove from a dataset comprising data for entity profiles of potential speakers and/or attendees) any entity profiles that are associated with medical entities outside of the distance threshold from the event location. The data processing system may then execute the model and/or the optimization model using only data for the medical entities that are within the threshold distance of the event, thus minimizing the data the data processing system processes when selecting optimal attendees and/or speakers.

At operation 412, the data processing system can select a speaker and an attendee based on an output of the optimization model. The data processing system may select the speaker and the attendee in a manner dependent on the configuration of the optimization model. For example, in some implementations, the data processing system may execute the optimization model and generate a ranking of the highest rated speakers and/or attendees (ranked in order based on who most optimizes an objective function). In such implementations, the data processing system may select the highest rated speaker (or speakers if the request is for multiple speakers) and/or the highest rated attendees up to the capacity of the event In another example, in some implementations, the data processing system may execute the optimization model and generate scores for speakers and attendees (in some cases, the data processing system may calculate both a speaking score and an attendee score for one or more medical entities and an event). In such implementations, the data processing system may identify and select the highest scored speaker or speakers and the highest scored attendee or attendees. Accordingly, the data processing system may automatically select optimal speakers and/or attendees to attend events.

Responsive to selecting the speaker and the attendee, at operation 414, the data processing system can generate a record (e.g., a file, document, table, listing, message, notification, a user interface, an update to a user interface, etc.) comprising identifications of the speaker, the attendee, and the event. The record may include strings identifying each of the speaker, the attendee, and the event. The data processing system may store the generated record in memory or in a database for later retrieval. In some implementations, the data processing system may transmit the record to a client device to be displayed on a user interface (e.g., update the user interface with the record). By doing so, the data processing system may inform a user of the selected speaker and attendee for the event.

In some implementations, upon selecting the speaker and the attendee, the data processing system may automatically transmit records to the user interface of the application. The records may indicate that which speakers and attendees have been identified for the event and include attributes of the event (e.g., time, date, length, topic, who's been invite to speak, etc.).

Referring now to FIG. 4B, a flowchart of an example method 416 for implementing a multi-model architecture for linking speaker and attendee entity profiles is shown, in accordance with one or more implementations. The method 416 may be performed by a data processing system (e.g., the event optimization engine 202, the analytics server 310a, a client device 165, or any other computing device). The method 416 may include any number of steps and the steps may be performed in any order. Performance of the method 400 may enable the data processing system to use a series of models to automatically link speakers and attendees to events to optimize engagement at the events. By performing the method 400, the data processing system may link attendees and speakers to events without relying on any human guessing or analysis on an event-by-event basis, as is often done in conventional systems.

At operation 418, the data processing system can receive clinical data for a plurality of medical entities. At operation 420, the data processing system can generate entity profiles and a network graph data structure from the clinical data. At operation 422, the data processing system can calculate clinical metrics and online interaction metrics for the entity profiles. The data processing system can perform the operations 418-422 in the same or a similar manner to how the data processing system performs the operations 402-406.

At operation 424, the data processing system can execute one or more models to generate composite scores for the plurality of entity profiles. For example, the data processing system can generate a composite score for an entity profile based on the following data for the entity profile: a medical entity score, an attendance probability, a Dijkstra's score, a degree of connection, and a topic affinity. The data processing system can generate a feature vector from each of the values. The data processing system can input the feature vector into a machine learning model (e.g., a neural network, support vector machine, a random forest, etc.). The data processing system can execute the machine learning model with the feature vector as input to generate a composite score for the entity profile. The data processing system can similarly generate composite scores for any number of entity profiles.

The data processing system can calculate data for entity profiles using different models. For example, the data processing system can calculate the medical entity score using the TOPSIS algorithm in the same manner and/or using the same data as the data processing system used to calculate the speaker score for different entity profiles. In another example, the data processing system can use a Criteria Importance through Inter Criteria Correlation (CRITIC) technique to determine the medical entity scores for the entity profiles. The data processing system can use the same techniques to determine weights as described above with respect to the TOPSIS algorithm to determine weights and/or parameters for the CRITIC technique. The data processing system can also input the same data into the model configured to perform the CRITIC technique to calculate medical entity scores for entity profiles. Medical entity scores can be similar to or the same as the speaker scores described above. The data processing system can determine attendance probabilities for entity profiles using the same data and techniques (e.g., XGBoost or a tree-based model) as the data and techniques described with respect to the operation 408 to calculate attendee scores for entity profiles. Attendance probabilities can be similar to or the same as the attendee scores described above.

The data processing system can calculate scores or metrics for the entity profiles. The data processing system can do so based on the network graph data structure the data processing system generated for the different entity profiles. For example, the data processing system can calculate affinity scores (e.g., Dijkstra scores) for the entity profiles. The data processing system can calculate affinity scores using Dijkstra's short path algorithm on the network graph data structure linking nodes of different entity profiles of medical entities. For each entity profile, the data processing system can calculate a Dijkstra score between the entity profile and the other entity profiles of the network graph data structure. The data processing system can calculate an average of the Dijkstra scores to calculate an affinity score for the entity profile. The data processing system can similarly calculate a degree of connection for each entity profile using Dijkstra's short path algorithm (e.g., for each entity profile in the network graph data structure, the data processing system can calculate a degree of connection between the entity profile and each other entity profile of the network graph data structure and calculate the average of the degrees of connection). Accordingly, the data processing system can calculate values indicating the strength of the relationships between individual medical entities as a whole.

The data processing system can calculate topic affinity scores for the entity profiles. The data processing system can calculate a topic affinity score for an entity profile for each of multiple topics such that an entity profile can have or store multiple topic affinity scores. In some implementations, the data processing system can calculate a topic affinity score for a topic for each entity profile responsive to receiving a request including an identification of the topic for a recommended speaker and/or recommended attendees for a speaking event on the topic.

The data processing system can calculate topic affinity scores for entity profiles using a cosine similarity technique. To do so, for example, for an entity profile of a medical entity, the data processing system can retrieve clinical data (e.g., social media data, PubMed data, congress data, etc.) that is associated with the medical entity (e.g., that the medical entity wrote or that otherwise names the medical entity). In some implementations, the data processing system can only retrieve clinical data that is related to (e.g., has a stored association with) a topic. The data processing system can convert each of the retrieved pieces of data (e.g., documents or posts) into a vector and the topic into a vector (e.g., an embedding). The data processing system can calculate the cosines of the angles between the vector for the topic and each of the documents or posts to calculate the similarity between the individual documents and the topic. The data processing system can calculate an average or median of the calculated similarities to calculate an affinity score between the entity profile and the topic. The data processing system can calculate affinity scores between any number of entity profiles and any number of topics.

The data processing system can calculate a composite score for an entity profile (e.g., for a medical entity). The data processing system may do so by executing a machine learning model or by performing any other calculation (e.g., a sum, average, median, etc.) on one or more of a medical entity score, an attendance probability, a Dijkstra's score, a degree of connection, or a topic affinity for an entity profile. The data processing system can generate such composite scores for any number of entity profiles.

In one example, the data processing system can generate composite scores for entity profiles based on historical attendance data of the entity profiles and relationships between the entity profiles stored in the network graph data structure. For example, the data processing system can identify and/or retrieve the stored relationships between entity profiles in the network graph data structure. The data processing system can execute an affinity model using identifiers of the plurality of entity profiles and the stored relationships between the plurality of entity profiles in the network graph data structure as input to generate one or more affinity scores for the plurality of entity profiles. For instance, the data processing system can execute the affinity model to calculate one or more degrees of relationship (e.g., degrees of connection) for the stored relationships between entity profiles in the network graph data structure. The data processing system can also execute the affinity model to calculate affinity scores for each of the entity profiles based on the stored relationships in the network graph data structure. The data processing system can receive historical event attendance data (e.g., data indicating events that the medical entities of the entity profiles attended and data regarding the event (e.g., the speakers and/or type or subject of the event)) for the plurality of entity profiles. The data processing system can execute a historical attendance model using identifiers of the plurality of entity profiles and the historical event attendance data as input to generate one or more attendance probabilities (e.g., attendance scores). For instance, executing the historical attendance model can include executing an XGBoost or a tree-based model based on historical attendance data to calculate attendance probabilities for the individual entity profiles. The data processing system can execute a composite model (e.g., a machine learning model, such as a neural network, random forest, or support vector machine) using the one or more affinity scores and/or the one or more attendances scores (in some cases in addition to other calculated scores or values) for the plurality of entity profiles as input to generate the one or more composite scores.

In some implementations, the data processing system can filter out entity profiles before calculating any values or scores for the entity profiles. The data processing can filter out entity profiles based on compliance rules and/or data for the event. For example, in a request for a list including a speaker and/or attendees for an event, the request can include a set of compliance rules that include one or more of a geographic location for the event, a distance threshold, and/or a time threshold. In some implementations, the distance threshold and/or the time threshold can be stored values that the data processing system can retrieve upon identifying a speaker and/or attendees for an event. The data processing system can identify, from memory, a first set of entity profiles of the network graph data structure that have stored associations with geographic locations within the distance threshold of the geographic location for the event. The data processing system can identify a second set of entity profiles of the network graph data structure that do not have an indication that the medical entities associated with the second set of entity profiles have attended an event within the time threshold (e.g., attendance data for the second set of entity profiles indicate does not include an indication of an attended event within the time threshold). The data processing system can identify entity profiles that are in both the first set of entity profiles and the second set of entity profiles as a third set of entity profiles. The data processing system can calculate scores and/or composite scores only for the entity profiles in the third set of entity profiles. Accordingly, the data processing system can conserve processing resources by minimizing the computation of generating scores for every entity profile in memory. Such computer resource savings can be considerable given the large amount of entity profiles the data processing system may store in memory.

At operation 426, the data processing system can execute an optimization model. The optimization model can be or include a mixed-integer programming model or another type of optimization model (e.g., a linear programming model, a nonlinear programming model, a constraint programming model, etc.). The data processing system can execute the optimization model using the calculated composite scores for the entity profiles as input. In some implementations, the data processing system can input one or more of the medical entity scores, attendance probabilities, Dijkstra's scores, degrees of connection, or topic affinities for the entity profiles into the optimization model in addition to or instead of the calculated composite scores into the optimization model. The optimization model can be weighted (e.g., manually weighted) based on inputs from a user. The data processing system can execute the optimization model to maximize the output of the optimization model based on the input. For example, the data processing system can execute the optimization model to cause the optimization model to output a list of one or more medical entities or entity profiles that maximize an optimization function.

In some implementations, the data processing system can filter out entity profiles before including the scores or values for the entity profiles in the input into the optimization model. The data processing system may do so prior to calculating the composite scores and/or prior to executing the optimization model to avoid using processing resources to perform calculations for entity profiles that would not be selected. The data processing system can filter out the entity profiles as described above with reference to the operation 410 (e.g., based on one or more rules, such as rules restricting a speaker from speaking or attending events of the same topic in a row or based on the medical entities living too far away (e.g., a distance above a threshold) from the location of an event). The data processing system can filter out entity profiles based on any rules or conditions.

At operation 428, the data processing system can select a speaker and one or more attendees for the event. The data processing system can select the speaker and the one or more attendees based on the generated composite scores for the entity profiles. The data processing system can select the speaker and the one or more attendees based on the output list of medical entities or entity profiles that the optimization model generates from the input scores and/or values for the medical entities or entity profiles. For example, the data processing system can select a speaker for the event from the list of medical entities output by the optimization model. The data processing system can select the speaker responsive to the speaker corresponding to a highest composite score of the medical entities or entity profiles of the list. The data processing system can select the speaker responsive to determining the selected speaker has not spoken at an event within a defined time period (in which case the data processing system can select the entity profile associated with the next highest composite score to be the speaker at the event). The data processing system can select the remaining medical entities or entity profiles from the list to be attendees for the event. The data processing system can use any criteria to limit which entity profiles can be selected to be attendees and/or speakers. The data processing system can use any technique to select a speaker and/or one or more attendees for an event based on the composite scores of the entity profiles and/or the output of the optimization model.

At operation 430, the data processing system can generate a record. The data processing system can generate the record to include identifications of the selected speaker, one or more attendees, and/or the event. The data processing system can perform the operation 430 in the same or a similar manner to the manner described with respect to the operation 414.

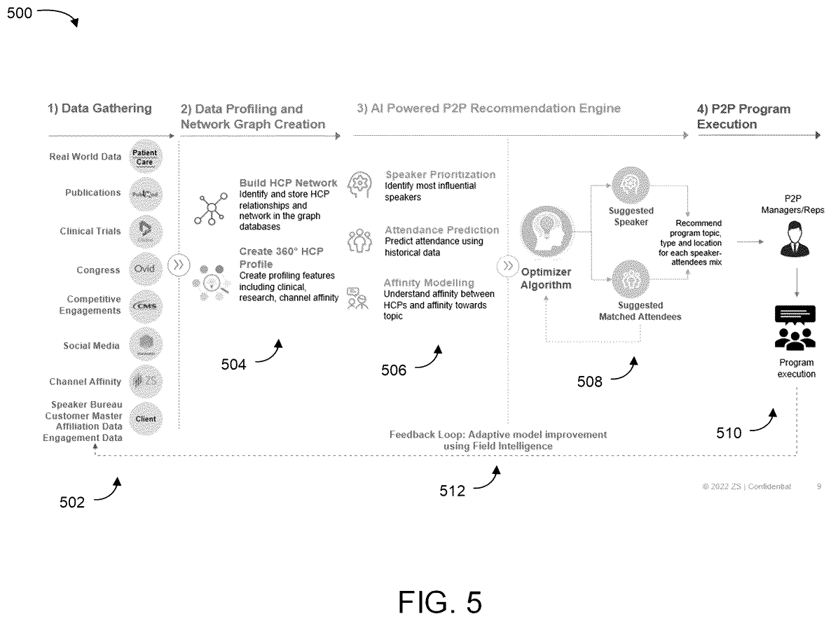

Referring now to FIG. 5, an example sequence 500 of implementing a multi-model architecture for linking speaker and attendee entity profiles is shown, in accordance with one or more implementations. The sequence 500 may be performed by a data processing system (e.g., the event optimization engine 202, the analytics server 310a, a client device 165, or any other computing device). The sequence 500 may include any number of steps and the steps may be performed in any order. In some implementations, performance of the sequence 500 may enable the data processing system to identify mixes of speakers and/or attendees that correspond to different attributes of an event.

At operation 502, the data processing system can gather (e.g., receive and/or retrieve) clinical data from a variety of data sources. The data processing system may gather the clinical data using one or more application programming interfaces that enable the data processing system to connect and/or communicate with the computers of the data sources over a network. At an operation 504, the data processing system can generate a network graph data structure and entity profiles for medical entities. The data processing system may do so using the clinical data the data processing system gathered. At an operation 506, the data processing system may generate speaker scores that indicate the most influential speakers, attendance scores indicating the medical entities that would be the most likely to attend an event, and/or affinity scores indicating the relationships between different medical entities.

At operation 508, the data processing system may insert the scores calculated at operation 506 into an optimization algorithm or model. In doing so, the data processing system may generate a list of suggested speakers and/or attendees. The list may include the suggested speakers and/or attendees based on how they optimize an objective function of the optimization algorithm. In some implementations, the suggested speakers and/or attendees may be grouped together because while one attendee or set of attendees may optimize the objective function with one speaker, the same attendee or set of attendees may not optimize the objective function with another speaker. This may be because the optimization algorithm or model may take into account the relationships or connections between different medical entities when maximizing the objective function, so the lack of a connection with a speaker may have a negative impact on the attendee or speaker with the optimization algorithm.

In some implementations, upon executing the optimization algorithm, the data processing system may identify optimal event topics, types, and locations for different speaker-attendee mixes. For instance, when executing the optimization algorithm and/or the models to determine the scores to use as input into the optimization algorithm, the data processing may input different event attributes into the algorithm or models. Because of the different connections and relationships different medical entities may have with such attributes, executing the models and/or optimization algorithm to identify optimal groups of speakers and/or attendees may result in the data processing system identifying different mixes of medical entities for different mixes of event attributes. This may be useful, for example, if an event planner were determining which events to hold over time or within a set time period for a program and the event planner could select a button on a user interface provided by the data processing system to cause the data processing system to automatically generate the mixes of attendees and speakers and the sets of attributes that best correspond to the mixes. At operation 510, the data processing system may transmit the mixes with the corresponding sets of attributes to the requesting computing device.

At operation 512, the data processing system may add any data the data processing system generated to the clinical data the data processing system added to the entity profiles in the network graph data structure. The data processing system may identify the data and insert the data into the entity profiles that are associated with the respective pieces of data. For example, the data processing system may insert indications of the event and whether a medical entity was selected as an attendee or a speaker into the profiles of the entities that were selected for each role. By doing so, the data processing system may later use the data to determine which events the medical entities have attended and/or spoken at. The data processing system may then later use such data to determine if any rules (e.g., affinity rules) are satisfied and the entity profiles are to be filtered out or selected to be attendees or speakers for future events.

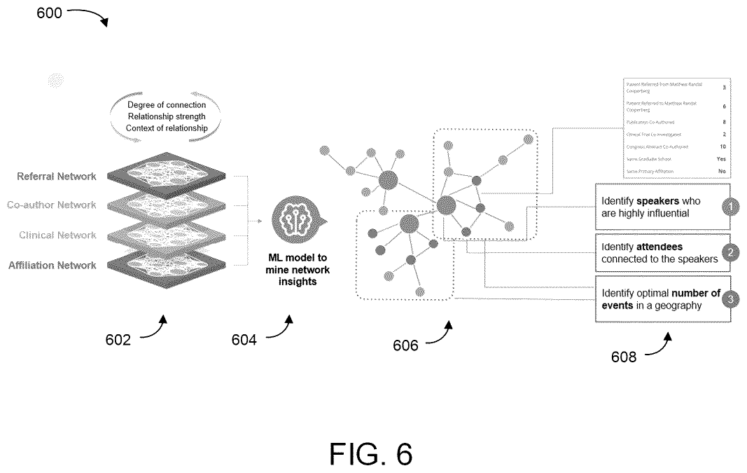

Referring now to FIG. 6, another example sequence 600 of implementing a multi-model architecture for linking speaker and attendee entity profiles is shown, in accordance with one or more implementations. The sequence 600 may be performed by a data processing system (e.g., the event optimization engine 202, the analytics server 310a, a client device 165, or any other computing device). In some implementations, performance of the sequence 600 may enable the data processing system to identify influential speakers, attendees connected to the speakers, and/or an optimal number of events in a geographical area using a network graph data structure.

At operation 602, the data processing system may generate a network graph data structure from clinical data. The network graph data structure may generate the network graph data structure with layers of connections of different types. For instance, as illustrated, the data processing system may generate the network graph data structure to generate the network graph from connections generated from referrals, co-authorship, clinical relationships, and/or affiliations. When generating the connections, the data processing system may generate the connections in the profiles of the network graph data structure with an identification of the degree of the connection, the strength of the connection (e.g., the affinity score), and/or the context of the connection (e.g., the data the data processing system identified that caused the data processing system to generate the connections).

At operation 604, the data processing system may input data from the network graph data structure into one or more machine learning models. The machine learning models may be configured to generate insights into the entity profiles to select the optimal speakers and attendees for an event, and other types of data. For instance, at operation 606, the data processing system may generate a network graph data structure from the output of the machine learning models and generate context data indicating the basis for the relationships or connections within the network graph data structure. Concurrently or using the network graph data structure, at operation 608, using the systems and methods described herein, the machine learning models and/or other models as described herein may automatically identify or select speakers and/or attendees for events.

In some implementations, the data processing system may automatically generate the optimal number of events in a particular geographical area. The data processing system may do so by identifying the speakers and/or attendees with the highest scores. Using an optimization model, the data processing system may identify the most optimal pairing of speakers and attendees. In this way, the data processing system may enable an event scheduler to schedule events such that each event is engaging and well-intended while avoiding scheduling events that will not be attended or engaging.

Referring now to FIG. 7, a non-limiting example of a graphical user interface 700 of an electronic platform enabling optimized speaker and attendee retrieval for an event is shown, in accordance with one or more implementations. A data processing system (e.g., the event optimization engine 202, the analytics server 310a, a client device 165, or any other computing device) may generate the user interface 700 and transmit the user interface 700 to a client device being accessed by a user to provide the user with access to the electronic platform and enable the user to request speakers and/or attendees for an event having an input set of attributes. For example, a user accessing a computing device (e.g., client 165) may establish a connection with the data processing system. The user may input attributes 702 (e.g., event type, event location, and event topic) into forms of the user interface. The data processing system may receive the input attributes 702 and select a speaker 704 and/or attendees 706 to recommend to the event using the systems and methods described herein. The data processing system may populate the user interface 700 on the computing device with the selected speaker 704 and the selected attendees 706.

In some implementations, the data processing system may present information about the recommended speaker 704 and the recommended attendees 706 on the user interface 700. To do so, upon or after selecting the speaker 704 and the attendees 706, the data processing system may retrieve the data that was used to select the speaker 704 and the attendees 706 (e.g., the metrics and/or the network graph data structure) and other information about the speaker 704 and the attendees 706 from their respective entity profiles. The data processing system may then present the retrieved information on the user interface 700. For instance, for the speaker 704, the data processing system may present demographic, employment information, information about the events the speaker 704 has conducted, when the speaker 704 last conducted an event, and/or a preferred method of contact. The data processing system may also automatically generate a description 708 as to the factors or metrics that played the biggest role (e.g., had the most impact) on the speaker 704 being selected. For the attendees 706, the data processing system may similarly generate descriptions as to why the attendees were recommended with demographic information and present the descriptions and demographic information on the user interface 700.

In some implementations, the data processing system may add attendees to attendees 706. The data processing system may do so in response to receiving a selection of an add attendee button 710 on the user interface 700. To do so, upon receiving the selection, the data processing system may retrieve a ranked list of attendees that was generated to select the speaker 704 and the current attendees 706. The data processing system may select the attendee with the highest ranking or score that has not yet been selected, and add the selected attendee to attendees 706. In some implementations, there may be a limit to the number of attendees that may be added to an event.

In some implementations, the data processing system may generate a filtered network graph 712 illustrating the connections and/or relationships of the selected speaker 704. As illustrated, the network graph 712 may include edges between entity profiles of medical entities the data processing system has determined have a relationship or a connection with each other. In some implementations, the data processing system may generate the network graph 712 to include a defined limit to the degrees of separation between the entity profile for the speaker 704 and another profile. For instance, the data processing system may limit the network graph 712 to illustrate each connection or relationship the speaker 704 directly has with another medical entity and then one to two more connections those medical entities have with other medical entities but that may not have a connection or relationship with the speaker 704. The data processing system may flag the profiles illustrated on the network graph 712 with a different color or shade based on the profiles being profiles for the attendees 706. By generating the network graph 712 in this way, the data processing system may help illustrate why the speaker 704 and/or attendees 706 were chosen.

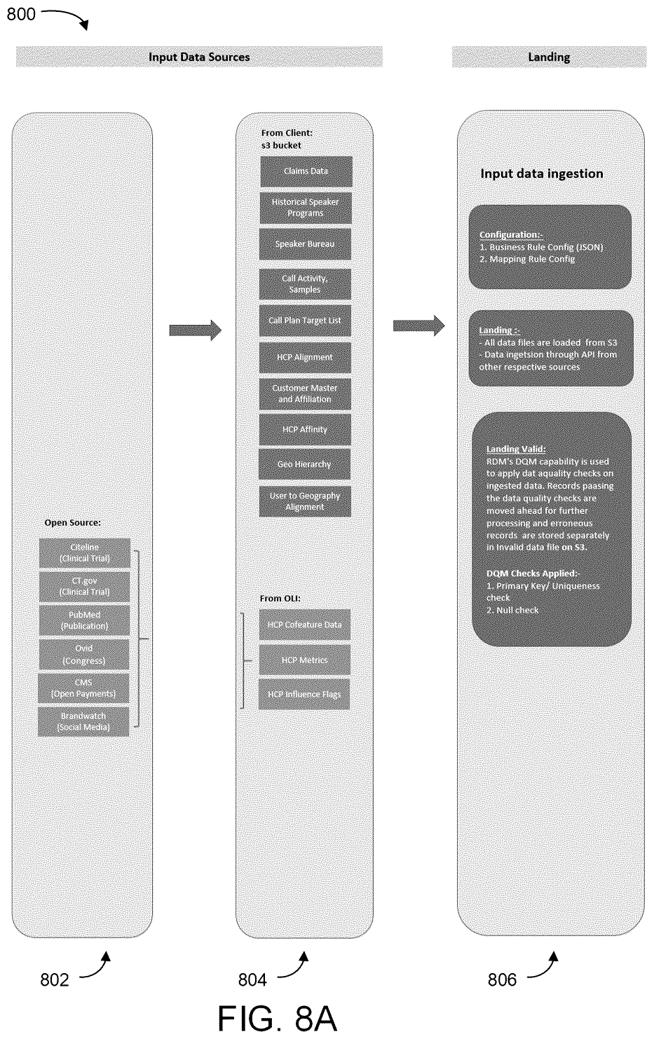

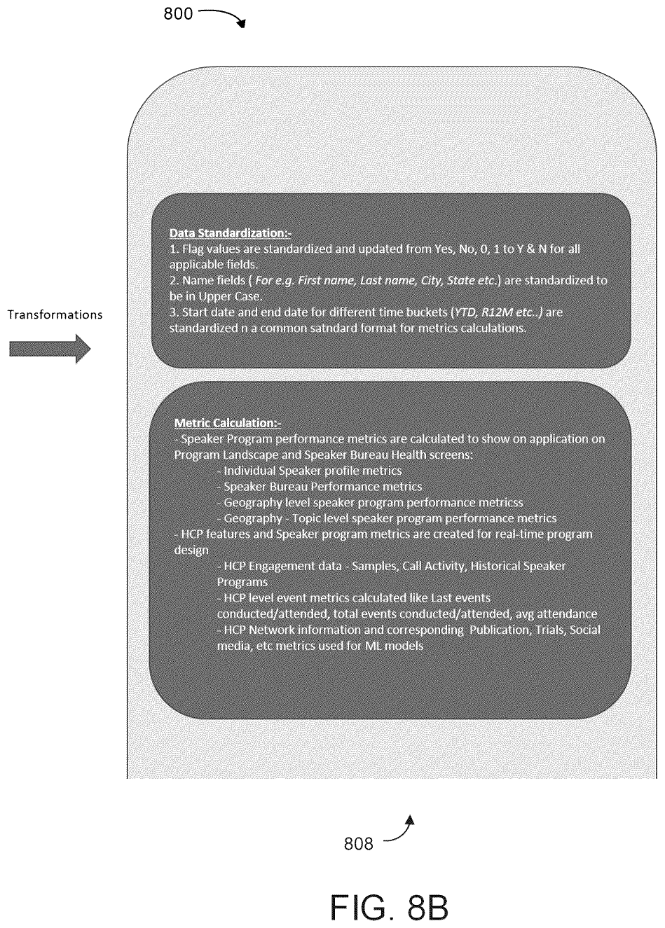

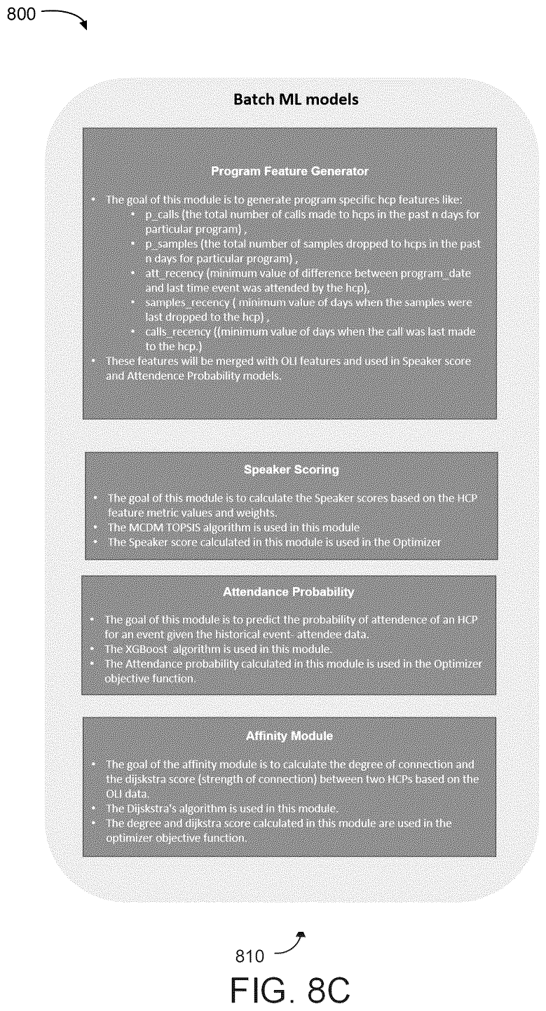

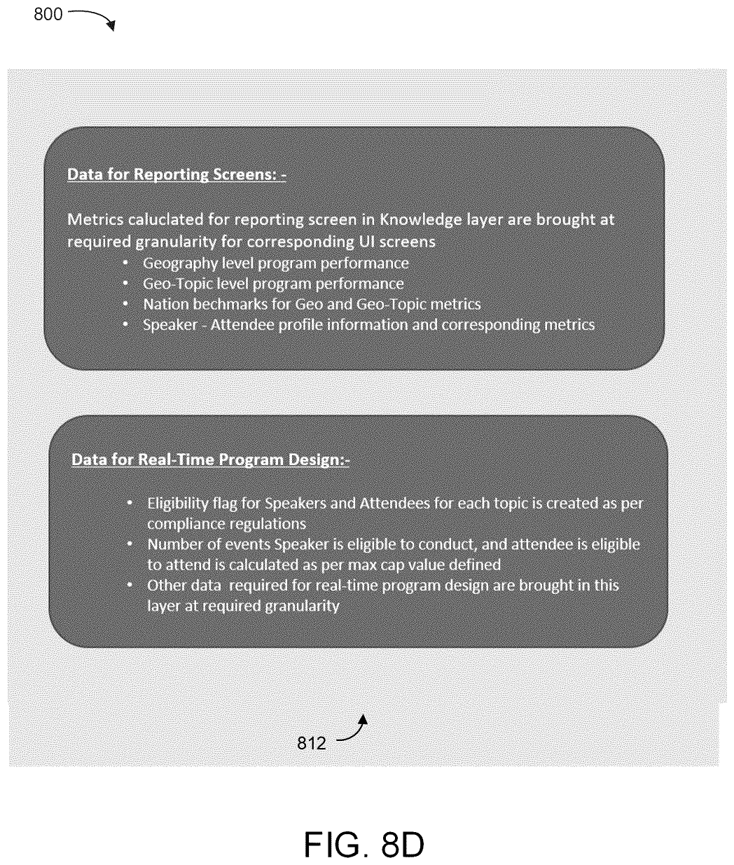

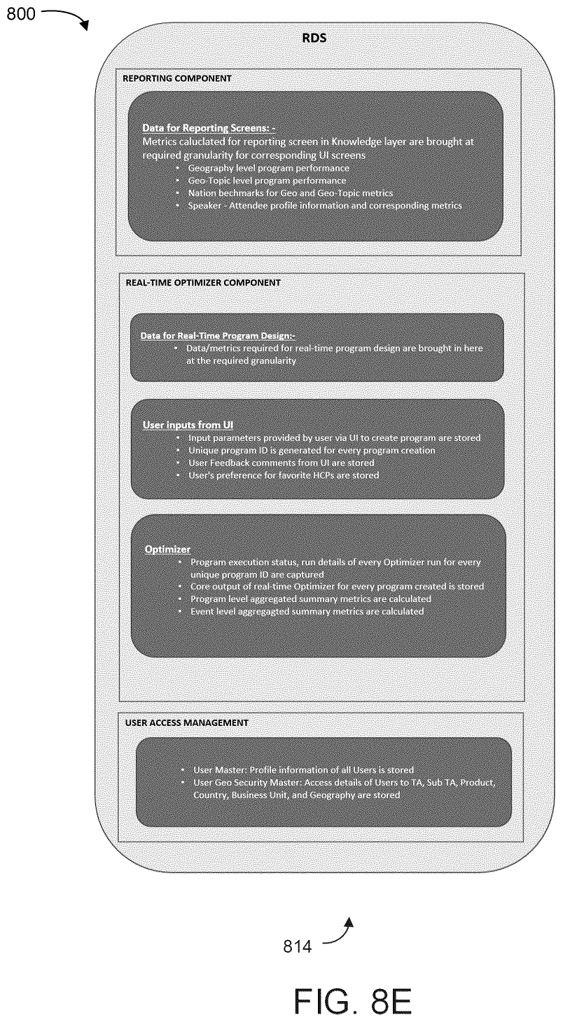

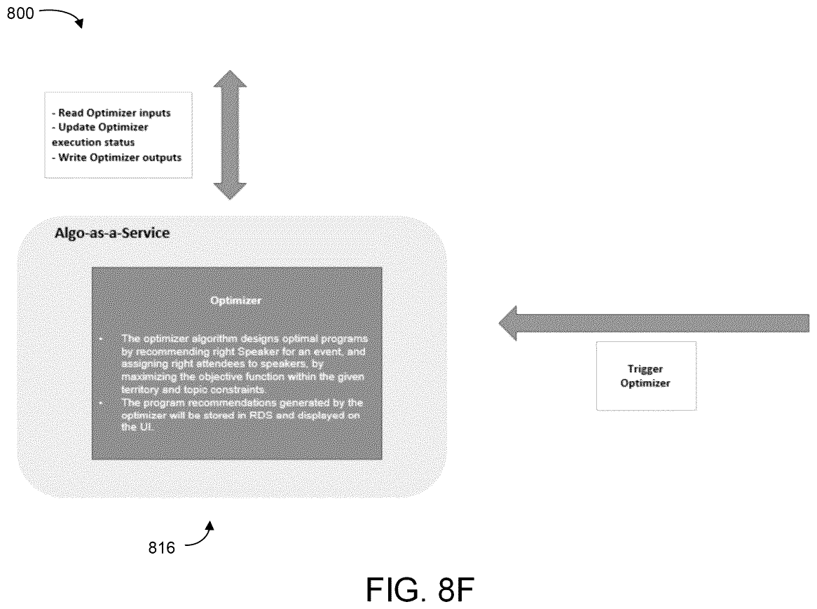

Referring now to FIG. 8A-F, a non-limiting example of a data flow 800 of a system implementing the systems and methods described herein is shown, in accordance with one or more implementations. In the data flow 800, a processor (e.g., a processor of the event optimization engine 202, the analytics server 310a, a client device 165, or any other computing device) may receive a variety of different types of clinical data.

For example, at operation 802, the processor may receive data from open-source resources (e.g., resources that are available to the public). In doing so, the processor may receive clinical data regarding clinical trials, publications, from Congress, open payments, and/or social media. At operation 804, the processor may receive data from a client that is requesting identifications of optimal speakers and/or attendees for events and/or calculate metrics from the received clinical data. In the data from the client, the processor may receive claims data, historical speaker program data, speaker bureau data, call activity and samples data, customer master and affiliation, medical entity affinity towards speaker program, a geographic hierarchy, and medical entity to geography alignment. The processor may calculate the metrics from the clinical data using the methods described herein.

At operation 806, the processor may ingest the received and calculated data. For instance, the processor may receive individual rules from the requesting computing device regarding how to select the attendees. The processor may load the data files from the client and ingest data from the open-source sources via one or more APIs. Upon loading all of the data, the processor may perform a quality check removing any duplicate data and/or null values in the data. Data records or files that pass the data quality checks may move ahead for further processing and erroneous records or data files (e.g., records or data files that contain duplicate values and/or null values) may be stored separately in a data file not for further use.

At operation 808, the processor may transform the data into a format executable computer models can read. For instance, the processor may standardize the data according to the following set of rules:
1. Flag values are standardized and updated from Yes, No, 0, 1 to Y & N for all applicable fields,
2. Name fields (For e.g. First name, Last name, City, State, etc.) are standardized to be in Upper Case, and
3. Start date and end date for different time buckets (YTD, R12M, etc.) are standardized n a common standard format for metrics calculations.
   The processor may also perform metric calculations according to the following sets of rules:
1. Speaker Program performance metrics are calculated to show on Program Landscape and Speaker Bureau Health screens:
   a. Individual Speaker profile metrics,
   b. Speaker Bureau Performance metrics,
   c. Geography level speaker program performance metrics, and
   d. Geography—Topic level speaker program performance metrics.
2. HCP (e.g., a medical entity or healthcare provider) features and Speaker program metrics are created for real-time program design
   a. HCP Engagement data—Samples, Call Activity, Historical Speaker Programs,
   b. HCP level event metrics calculated like Last events conducted/attended, total events conducted/attended, avg. attendance, and
   c. HCP Network information and corresponding Publication, Trials, Social media, etc., metrics used for ML models.

At operation 810, the processor may input the data into individual machine learning models to calculate speaker scores, attendee scores, and affinity scores. For instance, the processor may calculate speaker scores for medical entities based on the HCP features or weights using an MCDM TOPSIS algorithm. The processor may calculate attendee scores for medical entities based on historical event-attendance data of the medical entities using an XGBoost algorithm. The processor may calculate the degree of connection and the affinity scores between connected or related entity profiles based on the clinical data. In doing so, the processor may use the Dijkstra's algorithm to calculate the affinity score.

In some implementations, the processor may generate program-specific features. For example, the processor may generate:
1. p_calls (the total number of calls made to heps in the past n days for particular program),
2. p_samples (the total number of samples dropped to hcps in the past n days for particular program),
3. att_recency (minimum value of difference between program_date and last time event was attended by the hcp),
4. samples_recency (minimum value of days when the samples were last dropped to the hcp),
5. calls_recency ((minimum value of days when the call was last made to the hcp.)
   These features may be merged with the metrics calculated as described above and used in the models that calculate the speaker scores and attendee scores for medical entities.

At operation 812, the processor may calculate and store reporting metrics that can be presented to a user requesting data as to why the processor calculated the scores the processor calculated. For instance, the processor may calculate metrics for a reporting screen in the knowledge layer (e.g., operations 808 and/or 810) that are brought at a required granularity for corresponding user interface screens:
1. Geography level program performance,
2. Geo-Topic level program performance,
3. Nation benchmarks for Geo and Geo-Topic metrics, and
4. Speaker—Attendee profile information and corresponding metrics
   The processor may also calculate and store data for real-time program design including:
1. Eligibility flag for Speakers and Attendees for each topic is created as per compliance regulations,
2. Number of events Speaker is eligible to conduct, and attendee is eligible to attend is calculated as per max cap value defined, and
3. Other data required for real-time program design are brought in this layer at required granularity.

At operation 814, the processor may receive input parameters from a user via a user interface. The input parameters may be included with a request to create a program (e.g., a series of events on one or more topics as input by a user). Upon receiving the input parameters, the processor may create a program to be stored with a unique program identification. In some implementations, the processor may store feedback comments from the user interface and/or the user's preferences for favorite medical entities as well. Additionally, the processor may present outputs from an optimizer based on the user inputs and/or the calculated metrics. The outputs may include a program execution status and run details of every optimizer run for every unique program. The core output of the real-time optimizer for every program created is stored. The processor may calculate program-level aggregated summary metrics as well as event-level aggregated summary metrics. Finally, user profile information for all users (e.g., event requesters) may be stored with access details (e.g., product, country, business unit, and/or geography) of the user.

At operation 816, the processor may execute an optimization model. The processor may execute the optimizer model using the speaker scores, attendee scores, affinity scores, and/or connection degrees as described above. The optimizer model may design optimal programs by recommending the optimal speaker for an event, and assigning the optimal attendees to speakers by maximizing the objective function within input geographic territory and topic constraints. Any program recommendations generated by the optimization model may be stored in memory and displayed on the user interface.

The input parameters may be included with a request to create a program. Upon receiving the input parameters, the processor may create a program to be stored with a unique program identification. In some implementations, the processor may store feedback comments from the user interface and/or the user's preferences for favorite medical entities as well. Additionally, the processor may present outputs from an optimizer based on the user inputs and/or the calculated metrics. The outputs may include a program execution status and run details of every optimizer run for every unique program. The core output of the real-time optimizer for every program created is stored. The processor may calculate program-level aggregated summary metrics as well as event-level aggregated summary metrics. Finally, user profile information for all users (e.g., event requesters) may be stored with access details (e.g., product, country, business unit, and/or geography) of the user.

The foregoing method descriptions and the process flow diagrams are provided merely as illustrative examples and are not intended to require or imply that the steps of the various embodiments must be performed in the order presented. The steps in the foregoing embodiments may be performed in any order and may be optional in some cases. Other steps may be performed between, before, or after any of the steps of the process flow diagrams. Words such as “then,” “next,” etc. are not intended to limit the order of the steps; these words are simply used to guide the reader through the description of the methods. Although process flow diagrams may describe the operations as a sequential process, many of the operations can be performed in parallel or concurrently. In addition, the order of the operations may be re-arranged. A process may correspond to a method, a function, a procedure, a subroutine, a subprogram, and the like. When a process corresponds to a function, the process termination may correspond to a return of the function to a calling function or a main function.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of this disclosure or the claims.

Embodiments implemented in computer software may be implemented in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the functions may be stored as one or more instructions or code on a non-transitory computer-readable or processor-readable storage medium. The steps of a method or algorithm disclosed herein may be embodied in a processor-executable software module, which may reside on a computer-readable or processor-readable storage medium. A non-transitory computer-readable or processor-readable media includes both computer storage media and tangible storage media that facilitate transfer of a computer program from one place to another. A non-transitory processor-readable storage media may be any available media that may be accessed by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used herein, include compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the embodiments described herein and variations thereof. Various modifications to these embodiments will be readily apparent to those skilled in the art, and the principles defined herein may be applied to other embodiments without departing from the spirit or scope of the subject matter disclosed herein. Thus, the present disclosure is not intended to be limited to the embodiments shown herein but is to be accorded the widest scope consistent with the following claims and the principles and novel features disclosed herein.

While various aspects and embodiments have been disclosed, other aspects and embodiments are contemplated. The various aspects and embodiments disclosed are for purposes of illustration and are not intended to be limiting, with the true scope and spirit being indicated by the following claims.

What we claim is:

1. A method comprising:
receiving, by a processor from a plurality of data sources, clinical data regarding a plurality of medical entities;
generating, by the processor from the clinical data, a plurality of entity profiles for the plurality medical entities and a network graph data structure comprising stored relationships between the plurality of entity profiles;
executing, by the processor, a model using identifiers of the plurality of entity profiles, an event topic, and the stored relationships between the plurality of entity profiles as input to generate, for an event associated with the event topic, one or more composite scores for the plurality of entity profiles;
selecting, by the processor, a speaker and one or more attendees for the event based on the generated one or more composite scores; and
generating, by the processor, a record comprising associations between identifications of the speaker, the one or more attendees, and the event.

2. The method of claim 1, wherein executing the model comprises executing, by the processor, a machine learning model trained to generate composite scores for entity profiles.

3. The method of claim 2, wherein selecting the speaker and the one or more attendees for the event comprises:
executing, by the processor, an optimization model based at least on the one or more composite scores; and
selecting, by the processor, the speaker and the one or more attendees for the event based on an output of the optimization model.

4. The method of claim 1, wherein receiving clinical data regarding the plurality of medical entity comprises retrieving, by the processor, a document having a plurality of authors,
wherein generating the plurality of entity profiles and the network graph data structure comprises:
extracting, by the processor, identifiers of a plurality of authors from the document; and
generating, by the processor, relationships between the plurality of authors in the network graph data structure responsive to the identifiers of the plurality of authors originating from the same document.

5. The method of claim 1, further comprising:
receiving, by the processor, the event topic from a form of a user interface generated by the processor; and
updating, by the processor, the user interface to include data of the record.

6. The method of claim 1, further comprising:
receiving, by the processor, a first geographic location for the event; and
identifying, by the processor, entity profiles of the network graph data structure that have stored associations with geographic locations within a distance threshold of the first geographic location,
wherein executing the model using the identifiers of the plurality of entity profiles as input comprises executing, by the processor, the model using only identifiers of the identified entity profiles.

7. The method of claim 1, further comprising:
identifying, by the processor, a first set of entity profiles of the network graph data structure comprising first historical attendance data indicating entities that have previously attended an event associated with the event topic and a second set of entity profiles of the network graph data structure comprising second historical attendance data indicating entities that have not previously attended any events associated with the event topic,
wherein executing the model using the identifiers of the plurality of entity profiles as input comprises executing, by the processor, the model using only identifiers of the second set of entity profiles.

8. The method of claim 1, wherein executing the model to generate the one or more composite scores comprises:
identifying, by the processor, the stored relationships between entity profiles in the network graph data structure; and
executing, by the processor, an affinity model using identifiers of the plurality of entity profiles and the stored relationships between the plurality of entity profiles in the network graph data structure as input to generate one or more affinity scores for the plurality of entity profiles, wherein executing the affinity model comprises calculating, by the processor, one or more degrees of relationship for the stored relationships between entity profiles in the network graph data structure based on each of the stored relationships;
receiving, by the processor, historical event attendance data for the plurality of entity profiles;
executing, by the processor, a historical attendance model using identifiers of the plurality of entity profiles and the historical event attendance data as input to generate one or more attendance scores; and
executing, by the processor, a composite model using the one or more affinity scores and the one or more attendances scores for the plurality of entity profiles as input to generate the one or more composite scores.

9. The method of claim 8, wherein executing the affinity model further comprises:
receiving, by the processor, a set of compliance rules, wherein the set of compliance rules comprises one or more of a geographic location for the event, a distance threshold, and a time threshold;
identifying, by the processor, a first set of entity profiles of the network graph data structure that have stored associations with geographic locations within the distance threshold of the geographic location;
identifying, by the processor from the historical event attendance data, a second set of entity profiles of the network graph data structure that do not have an indication of an event attendance data within the time threshold; and
identifying, by the processor, a third set of entity profiles of the network graph data structure that are in the first set of entity profiles and the second set of entity profiles,
wherein executing the model using the identifiers of the plurality of entity profiles as input comprises executing, by the processor, the model using only identifiers of the third set of entity profiles.

10. The method of claim 8, wherein selecting the speaker and the one or more attendees for the event comprises:
executing, by the processor, an optimization model based at least on the one or more composite scores; and
selecting, by the processor, the speaker and the one or more attendees for the event based on an output of the optimization model.

11. The method of claim 1, wherein receiving the clinical data comprises retrieving, by the processor, connection data from one or more social media websites; and
wherein generating the network graph data structure comprises generating, by the processor, one or more of the stored relationships in the network graph data structure based on the connection data.

12. A system comprising a server comprising a processor and a non-transitory computer-readable medium containing instructions that when executed by the processor cause the processor to perform operations comprising:
receiving, from a plurality of data sources, clinical data regarding a plurality of medical entities;
generating, from the clinical data, a plurality of entity profiles for the plurality medical entities and a network graph data structure comprising stored relationships between the plurality of entity profiles;
executing a model using identifiers of the plurality of entity profiles, an event topic, and the stored relationships between the plurality of entity profiles as input to generate, for an event associated with the event topic, one or more composite scores for the plurality of entity profiles;
selecting a speaker and one or more attendees for the event based on the generated one or more composite scores; and
generating a record comprising associations between identifications of the speaker, the one or more attendees, and the event.

13. The system of claim 12, wherein executing the model comprises executing a machine learning model trained to generate composite scores for entity profiles.

14. The system of claim 13, wherein selecting the speaker and the attendee for the event comprises:
executing an optimization model based at least on the one or more composite scores; and
selecting the speaker and the one or more attendees for the event based on an output of the optimization model.

15. The system of claim 12, wherein receiving clinical data regarding the plurality of medical entity comprises retrieving, by the processor, a document having a plurality of authors,
wherein generating the plurality of entity profiles and the network graph data structure comprises:
extracting, by the processor, identifiers of a plurality of authors from the document; and
generating, by the processor, relationships between the plurality of authors in the network graph data structure responsive to the identifiers of the plurality of authors originating from the same document.

16. The system of claim 12, the operations further comprising:
receiving a first geographic location for the event; and
identifying entity profiles of the network graph data structure that have stored associations with geographic locations within a distance threshold of the first geographic location,
wherein executing the model using the identifiers of the plurality of entity profiles as input comprises executing the model using only identifiers of the identified entity profiles.

17. The system of claim 12, the operations further comprising:
identifying, by the processor, a first set of entity profiles of the network graph data structure comprising first historical attendance data indicating entities that have previously attended an event associated with the event topic and a second set of entity profiles of the network graph data structure comprising second historical attendance data indicating entities that have not previously attended any events associated with the event topic,
wherein executing the model using the identifiers of the plurality of entity profiles as input comprises executing, by the processor, the model using only identifiers of the second set of entity profiles.

18. The system of claim 12, wherein executing the model to generate the one or more composite scores comprises:
identifying, by the processor, the stored relationships between entity profiles in the network graph data structure; and
executing, by the processor, an affinity model using identifiers of the plurality of entity profiles and the stored relationships between the plurality of entity profiles in the network graph data structure as input to generate one or more affinity scores for the plurality of entity profiles, wherein executing the affinity model comprises calculating, by the processor, one or more degrees of relationship for the stored relationships between entity profiles in the network graph data structure based on each of the stored relationships;
receiving, by the processor, historical event attendance data for the plurality of entity profiles;
executing, by the processor, a historical attendance model using identifiers of the plurality of entity profiles and the historical event attendance data as input to generate one or more attendance scores; and
executing, by the processor, a composite model using the one or more affinity scores and the one or more attendances scores for the plurality of entity profiles as input to generate the one or more composite scores.

19. A method comprising:
receiving, by a processor from a plurality of data sources, clinical data regarding a plurality of medical entities;
generating, by the processor from the clinical data, a plurality of entity profiles for the plurality medical entities and a network graph data structure comprising stored relationships between the plurality of entity profiles;
executing, by the processor, a model using identifiers of the plurality of entity profiles, an event topic, and the stored relationships between the plurality of entity profiles as input to generate, for an event associated with the event topic, one or more speaker scores, one or more attendee scores, and one or more affinity scores for the plurality of entity profiles;
selecting, by the processor, a speaker and one or more attendees for the event based on the generated one or more speaker scores, one or more attendee scores, and one or more affinity scores; and
generating, by the processor, a record comprising associations between identifications of the speaker, the one or more attendees, and the event.

20. The method of claim 19, wherein executing the model comprises executing, by the processor, a machine learning model trained to generate speaker scores, attendee scores, and affinity scores for entity profiles.
